(19) United States
(12) Patent Application Publication
(10) Pub. No.: US 2015/0140317 A1
(43) Pub. Date: May 21, 2015

(54) HIGH SURFACE AREA CATALYST

(71) Applicant: SDCmaterials, Inc., Tempe, AZ (US)

(72) Inventors: MAXIMILIAN A. BIBERGER, Scottsdale, AZ (US); Bryant Kearl, Phoenix, AZ (US); Xiwang Qi, Scottsdale, AZ (US); Qinghua Yin, Tempe, AZ (US); David Leamon, Gilbert, AZ (US)

(21) Appl. No.: 14/494,156

(22) Filed: Sep. 23, 2014

Related U.S. Application Data
(60) Provisional application No. 61/881,337, filed on Sep. 23, 2013.
(60) Provisional application No. 61/984,654, filed on Apr. 25, 2014.
(60) Provisional application No. 62/030,550, filed on Jul. 29, 2014.
(60) Provisional application No. 62/030,555, filed on Jul. 29, 2014.
(60) Provisional application No. 62/030,557, filed on Jul. 29, 2014.

(51) Int. Cl. B01J 35/02; B01J 21/04; B01J 37/02; B01J 21/08; B01J 21/18; B01J 23/44; B01J 31/06

(52) U.S. Cl. CPC B01J 35/026; B01J 23/44; B01J 21/04; B01J 31/068; B01J 21/08; B01J 21/18; B01J 37/0221; B01J 37/0213
USPC 428/317.9; 502/325; 502/339; 502/300; 502/355; 502/303; 502/304; 502/159; 502/232; 502/180; 502/100

(57) ABSTRACT

The present invention relates to the field of catalysts, and more specifically to nanoparticle catalysts. Materials with high porosity which contain nanoparticles can be created by various methods, such as sol-gel synthesis. The invention provides catalytic materials with very high catalytically active surface area, and methods of making and using the same. Applications include, but are not limited to, catalytic converters for treatment of automotive engine exhaust.

### CROSS-REFERENCE TO RELATED APPLICATIONS

This application claims priority benefit of U.S. Provisional Patent Application No. 61/881,337, filed Sep. 23, 2013, of U.S. Provisional Patent Application No. 61/984,654, filed Apr. 25, 2014, of U.S. Provisional Patent Application No. 62/030,550, filed Jul. 29, 2014, of U.S. Provisional Patent Application No. 62/030,555, filed Jul. 29, 2014, and of U.S. Provisional Patent Application No. 62/030,557, filed Jul. 29, 2014. The entire contents of those applications are hereby incorporated by reference herein.

### FIELD OF THE INVENTION

The present invention relates to the field of catalysts, and more specifically to nanoparticle catalysts.

### BACKGROUND OF THE INVENTION

In solid-state catalysts, efficiency of the catalyst is based, in part, on the amount of catalyst surface area exposed to a target substrate. Smaller and porous particles can generate greater surface area for the amount of catalytic material used. However, commercially available solid-state catalysts have been unable to fully optimize catalyst surface area.

Commercially available catalytic converters use platinum group metal (PGM) catalysts deposited on substrates by wet-chemistry methods, such as precipitation of platinum ions and/or palladium ions from solution onto a substrate. These PGM catalysts are a considerable portion of the cost of catalytic converters. Accordingly, any reduction in the amount of PGM catalysts used to produce a catalytic converter is desirable. Commercially available catalytic converters also display a phenomenon known as “aging,” in which they become less effective over time due, in part, to an agglomeration of the PGM catalyst, resulting in a decreased surface area. Accordingly, reduction of the aging effect is also desirable, in order to prolong the efficacy of the catalytic converter for controlling emissions.

### SUMMARY OF THE INVENTION

The invention provides novel materials comprising nano-particles, such as metal oxide nanoparticles, mixed-metal oxide nanoparticles, composite nanoparticle comprising a support nanoparticle and a catalytic nanoparticle, or any combination of the foregoing nanoparticles, which are bridged together by using a carrier material, thus forming highly porous micron-sized particles.

In one embodiment of the novel materials, particles comprising a nano-sized metal oxide, such as alumina, ceria, or a mixed metal oxide, such as cerium-zirconium oxide, cerium-zirconium-lanthanum oxide, or cerium-zirconium-lanthanum-yttrium oxide, are bridged together by using a carrier material. The carrier material can be a metal oxide, such as alumina or ceria, or a mixed-metal oxide, such as cerium-zirconium oxide, cerium-zirconium-lanthanum oxide, or cerium-zirconium-lanthanum-yttrium oxide. In one embodiment, nano-sized alumina particles are bridged together using a carrier material that comprises, or that reacts to form, alumina. In another embodiment, nano-sized ceria particles are bridged together using a carrier material that comprises, or that reacts to form, ceria; or are bridged together using a carrier material that comprises, or that reacts to form, cerium-zirconium oxide; or are bridged together using a carrier material that comprises, or that reacts to form, cerium-zirconium-lanthanum oxide; or are bridged together using a carrier material that comprises, or that reacts to form, cerium-zirconium-lanthanum-yttrium oxide. In another embodiment, nano-sized cerium-zirconium oxide particles are bridged together using a carrier material that comprises, or that reacts to form, ceria; or are bridged together using a carrier material that comprises, or that reacts to form, cerium-zirconium oxide; or are bridged together using a carrier material that comprises, or that reacts to form, cerium-zirconium-lanthanum oxide; or are bridged together using a carrier material that comprises, or that reacts to form, cerium-zirconium-lanthanum-yttrium oxide. In another embodiment, nano-sized cerium-zirconium-lanthanum oxide particles are bridged together using a carrier material that comprises, or that reacts to form, ceria; or are bridged together using a carrier material that comprises, or that reacts to form, cerium-zirconium oxide; or are bridged together using a carrier material that comprises, or that reacts to form, cerium-zirconium-lanthanum oxide; or are bridged together using a carrier material that comprises, or that reacts to form, cerium-zirconium-lanthanum-yttrium oxide. In another embodiment, nano-sized cerium-zirconium-lanthanum-yttrium oxide particles are bridged together using a carrier material that comprises, or that reacts to form, ceria; or are bridged together using a carrier material that comprises, or that reacts to form, cerium-zirconium oxide; or are bridged together using a carrier material that comprises, or that reacts to form, cerium-zirconium-lanthanum oxide; or are bridged together using a carrier material that comprises, or that reacts to form, cerium-zirconium-lanthanum-yttrium oxide.

In one embodiment of the novel materials, a catalytic particle that further enhances catalytic efficiency and with minimal PGM use, while reducing the effects of catalytic aging is desirable.

In some embodiments, a catalytic material comprises a porous carrier, and a plurality of composite nanoparticles embedded within the porous carrier, wherein each composite nanoparticle comprises a support nanoparticle and a catalytic nanoparticle.

In some embodiments, the catalytic material is a micron-size particle. In some embodiments, the catalytic nanoparticle comprises at least one platinum group metal. In some embodiments, the catalytic nanoparticle comprises platinum. In some embodiments, the catalytic nanoparticle comprises palladium. In some embodiments, the catalytic nanoparticle comprises platinum and palladium. In some embodiments, the catalytic nanoparticle comprises rhodium.

In some embodiments, the catalytic nanoparticle comprises platinum and palladium in a weight ratio of about 1:2 platinum:palladium to about 25:1 platinum:palladium. In some embodiments, the catalytic nanoparticle comprises platinum and palladium in a weight ratio of about 2:1 platinum:palladium to about 10:1 platinum:palladium. In some embodiments, the catalytic nanoparticle comprises platinum and palladium in a weight ratio of about 2:1 platinum:palladium. In some embodiments, the catalytic nanoparticle comprises platinum and palladium in a weight ratio of about 10:1 platinum:palladium. In some embodiments, the catalytic nanoparticle comprises platinum and is substantially free of palladium. In some embodiments, the catalytic nanoparticle comprises palladium and is substantially free of platinum. In some embodiments, the composite nanoparticles comprise about 0.001 wt % to about 20 wt % platinum group metal. In some embodiments, the composite nanoparticles comprise about 0.5 wt % to about 1.5 wt % platinum group metal.

In some embodiments, the support nanoparticle has an average diameter of 10 nm to 20 nm. In some embodiments, the catalytic nanoparticle has an average diameter between 0.3 nm and 10 nm.

In some embodiments, the support nanoparticle comprises a metal oxide. In some embodiments, the support nanoparticle comprising a metal oxide comprises aluminum oxide. In some embodiments, the support nanoparticle comprising a metal oxide comprises cerium oxide. In some embodiments, the support nanoparticle is a mixed-metal oxide. In some embodiments, the mixed-metal oxide comprises cerium-zirconium oxide, cerium-zirconium-lanthanum oxide, or cerium-zirconium-lanthanum-yttrium oxide.

In some embodiments, the porous carrier is formed from polymerized resorcinol. In some embodiments, the porous carrier comprises silica. In some embodiments, the porous carrier is formed from a mixture that comprises amorphous carbon. In some embodiments, the porous carrier comprises a metal oxide. In some embodiments, the porous carrier is formed from a mixture that comprises a metal oxide and polymerized resorcinol. In some embodiments, the metal oxide is or comprises aluminum oxide. In some embodiments, the metal oxide is or comprises cerium oxide. In some embodiments, the metal oxide is or comprises a mixed-metal oxide; in some embodiments, the mixed-metal oxide comprises cerium-zirconium oxide, cerium-zirconium-lanthanum oxide, or cerium-zirconium-lanthanum-yttrium oxide. In some embodiments, the porous carrier has an average pore surface area greater than about 200 m²/g. In each of these embodiments, the porous carrier is formed around the nanoparticles or composite nanoparticles, and the nanoparticles or composite nanoparticles are embedded in the porous carrier.

In some embodiments, the porous carrier has an average pore diameter of about 1 nm to about 200 nm.

In some embodiments, a method of producing a porous catalytic material comprises mixing composite nanoparticles with a fluid comprising a carrier precursor, wherein the composite nanoparticles comprise a support nanoparticle and a catalytic nanoparticle; solidifying the carrier precursor to form a solidified carrier, wherein the composite nanoparticles are embedded within the solidified carrier; and removing a portion of the solidified carrier to form a porous catalytic material. In these embodiments, the porous carrier is formed around the nanoparticles or composite nanoparticles.

In some embodiments, removing a portion of the solidified carrier, which carrier has been formed around the nanoparticle or composite nanoparticle, comprises calcining the solidified carrier to burn off a portion of the solidified carrier. In some embodiments, the method further comprises forming a fluid comprising dispersed composite nanoparticles prior to mixing the composite nanoparticles with the fluid containing a carrier precursor. In some embodiments, the carrier precursor comprises one or more of aluminum, silica, resorcinol, or amorphous carbon. In some embodiments, the carrier precursor comprises aluminum and resorcinol; the aluminum can be present as aluminum oxide. In some embodiments, the carrier precursor comprises cerium and resorcinol; the cerium can be present as cerium oxide. In some embodiments, the carrier precursor comprises a mixed-metal oxide; in some embodiments, the mixed-metal oxide comprises cerium-zirconium oxide, cerium-zirconium-lanthanum oxide, or cerium-zirconium-lanthanum-yttrium oxide.

In some embodiments, the carrier precursor comprises aluminum and amorphous carbon; the aluminum can be present in the form of aluminum oxide. In some embodiments, the carrier precursor comprises cerium and amorphous carbon; the cerium can be present in the form of cerium oxide. In some embodiments, the carrier precursor is solidified by precipitation and the composite nanoparticles co-precipitate with the solidified carrier. In some embodiments, the carrier precursor is solidified by polymerization.

In some embodiments, the catalytic nanoparticle comprises at least one platinum group metal. In some embodiments, the catalytic nanoparticle comprises rhodium. In some embodiments, the catalytic nanoparticle comprises platinum and palladium. In some embodiments, the catalytic nanoparticle comprises platinum and palladium in a weight ratio of about 1:2 platinum:palladium to about 25:1 platinum:palladium. In some embodiments, the catalytic nanoparticle comprises platinum and palladium in a weight ratio of about 2:1 platinum:palladium to about 10:1 platinum:palladium. In some embodiments, the catalytic nanoparticle comprises platinum and palladium in a weight ratio of about 2:1 platinum:palladium. In some embodiments, the catalytic nanoparticle comprises platinum and palladium in a weight ratio of about 10:1 platinum:palladium. In some embodiments, the catalytic nanoparticle comprises platinum and is substantially free of palladium. In some embodiments, the catalytic nanoparticle comprises palladium and is substantially free of platinum.

In some embodiments, the composite nanoparticles comprise about 0.001% to about 50% platinum group metal. In some embodiments, the composite nanoparticles comprise about 0.001% to about 40% platinum group metal. In some embodiments, the composite nanoparticles comprise about 0.001% to about 30% platinum group metal. In some embodiments, the composite nanoparticles comprise about 0.001% to about 20% platinum group metal. In some embodiments, the composite nanoparticles comprise about 0.5% to about 1.5% platinum group metal. In some embodiments, the support nanoparticle has an average diameter of about 10 nm to about 20 nm.

In some embodiments, the catalytic nanoparticle has an average diameter between about 0.3 nm and about 10 nm. In some embodiments, the support nanoparticle comprises a metal oxide. In some embodiments, the metal oxide is or comprises aluminum oxide. In some embodiments, the metal oxide is or comprises cerium oxide. In some embodiments, the metal oxide is or comprises a mixed metal oxide; in some embodiments, the mixed-metal oxide comprises cerium-zirconium oxide, cerium-zirconium-lanthanum oxide, or cerium-zirconium-lanthanum-yttrium oxide. In some embodiments, the catalytic material is calcined. In some embodiments, the method further comprises processing the resulting catalytic material into micron-sized particles. In some embodiments, the resulting catalytic material is ground to form micron-sized particles.

In some embodiments, a coated substrate comprises a substrate, and a washcoat layer comprising catalytically active particles, wherein the catalytically active particles comprise a porous carrier and a plurality of composite nanoparticles embedded within the porous carrier, wherein each composite nanoparticle comprises a support nanoparticle and a catalytic nanoparticle. The porous carrier is formed around the composite nanoparticles.

In some embodiments, the catalytic nanoparticle comprises at least one platinum group metal. In some embodiments, the catalytic nanoparticle comprises platinum and palladium. In some embodiments, the porous carrier is formed from polymerized resorcinol. In some embodiments, the porous carrier comprises silica. In some embodiments, the porous carrier is formed from a mixture that comprises amorphous carbon. In some embodiments, the porous carrier comprises a metal oxide. In some embodiments, the porous carrier is formed from a mixture that comprises a metal oxide and polymerized resorcinol. In some embodiments, the metal oxide is or comprises aluminum oxide. In some embodiments, the metal oxide is or comprises cerium oxide. In some embodiments, the metal oxide is or comprises a mixed metal oxide; in some embodiments, the mixed-metal oxide is or comprises cerium-zirconium oxide, cerium-zirconium-lanthanum oxide, or cerium-zirconium-lanthanum-yttrium oxide. In some embodiments, the porous carrier has an average pore surface area greater than 200 m²/g. In some embodiments, the porous carrier has an average pore diameter of 1 nm to 200 nm. In some embodiments, the substrate comprises cordierite. In some embodiments, the substrate comprises a honeycomb structure. In these embodiments, the porous carrier is formed around the nanoparticles or composite nanoparticles.

In some embodiments, a catalytic converter comprises the coated substrate. In some embodiments, an exhaust treatment system comprises a conduit for exhaust gas and the catalytic converter.

In some embodiments, a washcoat composition comprises catalytically active particles, wherein the catalytically active particles comprise a porous carrier and a plurality of composite nanoparticles embedded within the porous carrier, wherein each composite nanoparticle comprises a support nanoparticle and a catalytic nanoparticle. The porous carrier is formed around the composite nanoparticles.

In some embodiments, the catalytically active particles are suspended in an aqueous medium at a pH between 3 and 5. In some embodiments, the catalytic nanoparticle comprises at least one platinum group metal. In some embodiments, the catalytic nanoparticle comprises platinum and palladium. In some embodiments, the porous carrier is formed from polymerized resorcinol. In some embodiments, the porous carrier comprises silica. In some embodiments, the porous carrier is formed from a mixture that comprises amorphous carbon. In some embodiments, the porous carrier comprises a metal oxide. In some embodiments, the porous carrier is formed from a mixture that comprises a metal oxide and polymerized resorcinol. In some embodiments, the metal oxide is or comprises aluminum oxide. In some embodiments, the metal oxide is or comprises cerium oxide. In some embodiments, the metal oxide is or comprises a mixed metal oxide; in some embodiments, the mixed-metal oxide is or comprises cerium-zirconium oxide, cerium-zirconium-lanthanum oxide, or cerium-zirconium-lanthanum-yttrium oxide. In some embodiments, the porous carrier has an average pore surface area greater than 200 m²/g. In some embodiments, the porous carrier has an average pore diameter of 1 nm to 200 nm.

In some embodiments, a method of forming a coated substrate comprises coating a substrate with the washcoat composition. The method may further comprise calcining the substrate after coating with the washcoat composition.

In some embodiments, a catalytic material comprises a carrier comprising a combustible component and a non-combustible component, and a plurality of composite nanoparticles embedded within the gel, wherein each composite nanoparticle comprises a support nanoparticle and a catalytic nanoparticle.

In some embodiments, the combustible component is amorphous carbon. In some embodiments, the combustible component is a combustible gel. In some embodiments, the combustible component is polymerized resorcinol. In some embodiments, the catalytic nanoparticle comprises at least one platinum group metal. In some embodiments, the catalytic nanoparticle comprises rhodium. In some embodiments, the catalytic nanoparticle comprises platinum and palladium. In some embodiments, the catalytic nanoparticle comprises platinum and palladium in a weight ratio of 1:2 platinum:palladium to 25:1 platinum:palladium. In some embodiments, the catalytic nanoparticle comprises platinum and palladium in a weight ratio of 2:1 platinum:palladium to 10:1 platinum:palladium. In some embodiments, the catalytic nanoparticle comprises platinum and palladium in a weight ratio of 2:1 platinum:palladium. In some embodiments, the catalytic nanoparticle comprises platinum and palladium in a weight ratio of 10:1 platinum:palladium. In some embodiments, the catalytic nanoparticle comprises platinum and is substantially free of palladium. In some embodiments, the catalytic nanoparticle comprises palladium and is substantially free of platinum. In some embodiments, the composite nanoparticles comprise 0.001 wt % to 20 wt % platinum group metal. In some embodiments, the composite nanoparticles comprise 0.5 wt % to 1.5 wt % platinum group metal.

In some embodiments, the support nanoparticle has an average diameter of 10 nm to 20 nm. In some embodiments, the catalytic nanoparticle has an average diameter between 0.3 nm and 10 nm. In some embodiments, the support nanoparticle comprises a metal oxide. In some embodiments, the support nanoparticle comprising a metal oxide comprises aluminum oxide. In some embodiments, the support nanoparticle comprising a metal oxide comprises cerium oxide. In some embodiments, the support nanoparticle comprising a metal oxide comprises a mixed metal oxide; in some embodiments, the mixed-metal oxide comprises cerium-zirconium oxide, cerium-zirconium-lanthanum oxide, or cerium-zirconium-lanthanum-yttrium oxide.

In some embodiments, a method of producing a catalytic material comprises mixing composite nanoparticles with a fluid comprising a carrier precursor, wherein the composite nanoparticles comprise a support nanoparticle and a catalytic nanoparticle; and solidifying the carrier precursor to form a solidified carrier, wherein the composite nanoparticles are embedded within the solidified carrier, where the carrier has formed around the composite nanoparticles.

In some embodiments, the method further comprises forming a fluid comprising dispersed composite nanoparticles prior to mixing the composite nanoparticles with the fluid containing a carrier precursor. In some embodiments, the carrier precursor comprises a combustible component and a non-combustible component. In some embodiments, the combustible component comprises resorcinol or amorphous carbon. In some embodiments, the non-combustible component comprises aluminum or silica. In some embodiments, the carrier precursor comprises aluminum chloride. In some embodiments, the carrier precursor comprises cerium nitrate. In some embodiments, the carrier precursor comprises cerium nitrate and zirconium oxynitrate. In some embodiments, the carrier precursor comprises cerium nitrate, zirconium oxynitrate, and lanthanum acetate. In some embodiments, the carrier precursor comprises cerium nitrate, zirconium oxynitrate, lanthanum acetate, and yttrium nitrate. In some embodiments, the carrier precursor is solidified by precipitation and the composite nanoparticles co-precipitate with the solidified carrier. In some embodiments, the carrier precursor is solidified by polymerization.

In some embodiments, the catalytic nanoparticle comprises at least one platinum group metal. In some embodiments, the catalytic nanoparticle comprises rhodium. In some embodiments, the catalytic nanoparticle comprises platinum and palladium. In some embodiments, the catalytic nanoparticle comprises platinum and palladium in a weight ratio of 1:2 platinum:palladium to 25:1 platinum:palladium. In some embodiments, the catalytic nanoparticle comprises platinum and palladium in a weight ratio of 2:1 platinum:palladium to 10:1 platinum:palladium. In some embodiments, the catalytic nanoparticle comprises platinum and palladium in a weight ratio of 2:1 platinum:palladium. In some embodiments, the catalytic nanoparticle comprises platinum and palladium in a weight ratio of 10:1 platinum:palladium. In some embodiments, the catalytic nanoparticle comprises platinum and is substantially free of palladium. In some embodiments, the catalytic nanoparticle comprises palladium and is substantially free of platinum.

In some embodiments, the composite nanoparticles comprise about 0.001% to about 50% platinum group metal. In some embodiments, the composite nanoparticles comprise about 0.001% to about 40% platinum group metal. In some embodiments, the composite nanoparticles comprise about 0.001% to about 30% platinum group metal. In some embodiments, the composite nanoparticles comprise about 0.001% to about 20% platinum group metal. In some embodiments, the composite nanoparticles comprise about 0.5% to about 1.5% platinum group metal. In some embodiments, the support nanoparticle has an average diameter of about 10 nm to about 20 nm.

In some embodiments, the support nanoparticle has an average diameter of 10 nm to 20 nm. In some embodiments, the catalytic nanoparticle has an average diameter between 0.3 nm and 10 nm. In some embodiments, the support nanoparticle comprises a metal oxide. In some embodiments, the metal oxide is or comprises aluminum oxide. In some embodiments, the metal oxide is or comprises cerium oxide. In some embodiments, the metal oxide is or comprises a mixed metal oxide; in some embodiments, the mixed-metal oxide is or comprises cerium-zirconium oxide, cerium-zirconium-lanthanum oxide, or cerium-zirconium-lanthanum-yttrium oxide.

In some embodiments, the invention comprises a porous material comprising nanoparticles and a porous carrier material. The nanoparticles can be any one of metal oxide nanoparticles, mixed-metal oxide nanoparticles, or composite nanoparticles; or can be a mixture of metal oxide nanoparticles and composite nanoparticles, such as aluminum oxide nanoparticles and composite nanoparticles, or cerium oxide nanoparticles and composite nanoparticles; or can be a mixture of mixed-metal oxide nanoparticles and composite nanoparticles; or can be a mixture of metal oxide nanoparticles and mixed-metal oxide nanoparticles; or can be a mixture of metal oxide nanoparticles, mixed-metal oxide nanoparticles, and composite nanoparticles. In any of the foregoing embodiments, the metal oxide nanoparticles can comprise aluminum oxide, or the metal oxide nanoparticles can comprise cerium oxide, or the metal oxide nanoparticles can comprise a mixture of aluminum oxide nanoparticles and cerium oxide nanoparticles, or the metal oxide nanoparticles can comprise a mixture of aluminum oxide nanoparticles, cerium oxide nanoparticles cerium-zirconium oxide nanoparticles, cerium-zirconium-lanthanum oxide nanoparticles, and cerium-zirconium-lanthanum-yttrium oxide nanoparticles. In any of the foregoing embodiments, the composite nanoparticles can comprise a catalytic nanoparticle and a support nanoparticle; the support nanoparticle can be aluminum oxide, cerium oxide, cerium-zirconium oxide, cerium-zirconium-lanthanum oxide, or cerium-zirconium-lanthanum-yttrium oxide. In any of the foregoing embodiments, the catalytic nanoparticle can comprise rhodium, platinum, palladium, or an alloy of platinum and palladium. In any of the foregoing embodiments, the porous carrier material can be aluminum oxide; in preferred embodiments, the porous carrier material is aluminum oxide when the metal oxide nanoparticles are present in the carrier material and are aluminum oxide, and/or when the composite nanoparticles are present in the carrier material and the support nanoparticles of the composite nanoparticles are aluminum oxide. In any of the foregoing embodiments, the porous carrier material can be cerium oxide; in preferred embodiments, the porous carrier material is cerium oxide when the metal oxide nanoparticles are present in the carrier material and are cerium oxide, and/or when the composite nanoparticles are present in the carrier material and the support nanoparticles of the composite nanoparticles are cerium oxide. In all of the foregoing embodiments, the porous carrier material is formed around the nanoparticles. In all of the foregoing embodiments, the porous material comprising nanoparticles and a porous carrier material can be milled or otherwise formed into micron-sized particles of porous material comprising nanoparticles and a porous carrier material. In all of the foregoing embodiments where a composite nanoparticle is present and the composition of the support particle of the composite particle is not otherwise specified, the support nanoparticle can be a mixed-metal oxide.

### BRIEF DESCRIPTION OF THE DRAWINGS

FIG. 1 illustrates a catalytic converter in accordance with some embodiments of the invention. FIG. 1A shows an expanded view of a portion of FIG. 1.

FIG. 2 is a graph of CO light off temperature v PGM loading of a catalytic converter employing one embodiment of the present invention (open triangles) to a standard commercially available catalytic converter (filled squares, filled diamonds, and filled triangles) and a catalytic converter employing “nano-on-nano-on-micron” or NNm particles described in U.S. application Ser. No. 13/589,024 (U.S. Pat. No. 8,679,433) (filled circles).

FIG. 3 is a graph of CO light off temperature v PGM loading of a catalytic converter employing another embodiment of the present invention (open triangles) to a standard commercially available catalytic converter (filled squares, filled diamonds, and filled triangles) and a catalytic converter employing “nano-on-nano-on-micron” or NNm particles described in U.S. application Ser. No. 13/589,024 (U.S. Pat. No. 8,679,433) (filled circles).

### DETAILED DESCRIPTION OF THE INVENTION

Described are particles, washcoats, layers, and catalytic converters that include catalytically active materials, for example, composite nanoparticles embedded within a porous carrier. Also described are methods of making and using these materials. It has been found that by embedding composite nanoparticle catalysts within the porous carrier, the described catalysts provide for increased performance, illustrated, for example, by decreased carbon monoxide “light-off” temperatures and decreased platinum group metal loading, relative to prior catalysts such as catalysts prepared using wet-chemistry methods or other technologies using nanoparticles.

The described porous carrier is formed around the composite nanoparticles. The porous carrier surrounding the composite nanoparticles allows fluids to be treated, such as exhaust gas, to slowly flow through the pores of the porous carrier and contact very high surface area of the catalytic particles embedded within the porous carrier. This high surface allows for catalysis that is more efficient, for example by requiring lower amounts of platinum group metals. The porous carrier surrounding the composite nanoparticles also locks the composite nanoparticles in place to reduce agglomeration of the catalytic particles. The catalytic composite nanoparticles embedded within the porous carrier can include a catalytic nanoparticle attached to a support nanoparticle forming a “nano-on-nano” composite nanoparticle. The porous carrier is formed around the composite nanoparticles, in contrast to methods using pre-formed porous carrier particles (such as micron-sized alumina particles) as carriers for the composite nanoparticles. The porous carrier is formed around the composite nanoparticles by dispersing the nanoparticles in a precursor to the porous carrier; the precursor to the porous carrier is then converted into the porous carrier, thus forming the porous carrier around the composite nanoparticles.

As evident to one of skill in the art, as used herein, the term “embedded,” when describing nanoparticles embedded in a porous carrier, refers to the configuration of the nanoparticles in the porous carrier resulting when the porous carrier is formed around the nanoparticles, generally by using the methods described herein. That is, the resulting structure contains nanoparticles with a scaffolding of porous carrier built up around or surrounding the nanoparticles. The porous carrier encompasses the nanoparticles, while at the same time, by virtue of its porosity, the porous carrier permits external gases to contact the embedded nanoparticles.

As described herein, the porous carrier with embedded composite nanoparticles can be used to produce micron-sized catalytic particles. This configuration offers many advantages over micron-sized particles bearing composite nanoparticles just on the surface of or within the surface-accessible pores of pre-formed micron-sized carrier particles (the surface-accessible pores are the pores of the micron-sized carrier particle that are large enough to accept the composite nanoparticles, and which are accessible to the composite nanoparticles from the surface). In technologies using micron-sized carrier particles bearing composite nanoparticles on the surface or within surface-accessible pores of the micron-sized particles, a slurry of composite nanoparticles is generally applied to pre-formed micron-sized particles, for example commercially available micron-sized metal oxide particles, until the point of incipient wetness. That process impregnates composite nanoparticles on the surface of the micron-sized carrier particle and within pores of the micron-sized carrier particle that are large enough to accept the composite nanoparticles (the surface-accessible pores). Furthermore, when applying composite nanoparticles only onto the surface of a micron-sized carrier particle, some composite nanoparticles may be buried underneath other composite nanoparticles within the pores of the micron particle and, thus, inaccessible to target gases and unable to contribute to catalytic activity.

In some embodiments, composite nanoparticles embedded within a porous carrier are produced by mixing composite nanoparticles, such as those described in US 2011/0143915, the disclosure of which is hereby incorporated by reference in its entirety, with a fluid comprising a carrier precursor. The carrier precursor is then solidified, for example by precipitation or polymerization of the carrier precursor components, locking the composite nanoparticles embedded within the carrier. However, the high porosity of the carrier formed around the composite nanoparticles ensures that gases flowing through the porous carrier are able to contact the embedded nanoparticles. In some embodiments, the carrier precursor comprises a combustible component, for example a polymerized organic gel or amorphous carbon, and a non-combustible component, such as a metal oxide, for example aluminum oxide. In some embodiments, the carrier precursor comprises a combustible component, for example a polymerized organic gel or amorphous carbon, and a non-combustible component, such as a precursor to a metal oxide, for example aluminum chloride, cerium nitrate, zirconium oxynitrate, lanthanum acetate, or yttrium nitrate. In some embodiments, a portion of the solidified carrier, for example the combustible component, is removed, for example, by calcining the material, resulting in composite nanoparticles embedded within a porous carrier. In some embodiments, the resulting catalytic material is processed into micron-sized particles, termed “nano-on-nano-in-micro” or “NNiM” particles.

NNiM particles can be used in many catalytic applications. For example, in some embodiments, NNiM particles may be used in washcoat formulations that can be coated on catalytic substrates used to make catalytic converters. Coated substrates and catalytic converters using NNiM particles efficiently catalyze exhaust gas emitted by vehicles.

Composite nanoparticles used to produce NNiM particles include a catalytic nanoparticle and a support nanoparticle bonded together to form nano-on-nano composite nanoparticles. These composite nanoparticles may then be embedded within a porous carrier which is formed around the composite nanoparticles, which may be used to form micron-sized catalytically active particles. The composite nanoparticles may be produced, for example, in a plasma reactor in such a way that consistent nano-on-nano composite particles are produced. These composite particles are then embedded within a porous carrier formed around the composite nanoparticles, which can be used to produce porous micron-sized catalytically active particles with embedded composite nanoparticles, which may offer better performance over the lifetime of the catalyst and/or less reduction in performance over the life of the catalyst as compared to previous catalysts, such as catalysts prepared using wet-chemistry methods or other nanoparticle technologies, such as those using composite nanoparticles disposed on the surface of micron-sized particles.

When numerical values are expressed herein using the term “about” or the term “approximately,” it is understood that both the value specified, as well as values reasonably close to the value specified, are included. For example, the description “about 50° C.” or “approximately 50° C.” includes both the disclosure of 50° C. itself, as well as values close to 50° C. Thus, the phrases “about X” or “approximately X” include a description of the value X itself. If a range is indicated, such as “approximately 50° C. to 60° C.,” it is understood that both the values specified by the endpoints are included, and that values close to each endpoint or both endpoints are included for each endpoint or both endpoints; that is, “approximately 50° C. to 60° C.” is equivalent to reciting both “50° C. to 60° C.” and “approximately 50° C. to approximately 60° C.”

The word “substantially” does not exclude “completely.” E.g., a composition which is “substantially free” from Y may be completely free from Y. The term “substantially free” permits trace or naturally occurring impurities. It should be noted that, during fabrication, or during operation (particularly over long periods of time), small amounts of materials present in one washcoat layer may diffuse, migrate, or otherwise move into other washcoat layers. Accordingly, use of the terms “substantial absence of” and “substantially free of” is not to be construed as absolutely excluding minor amounts of the materials referenced. Where necessary, the word “substantially” may be omitted from the definition of the invention.

This disclosure provides several embodiments. It is contemplated that any features from any embodiment can be combined with any features from any other embodiment. In this fashion, hybrid configurations of the disclosed features are within the scope of the present invention.

It is understood that reference to relative weight percentages in a composition assumes that the combined total weight percentages of all components in the composition add up to 100. It is further understood that relative weight percentages of one or more components may be adjusted upwards or downwards such that the weight percent of the components in the composition combine to a total of 100, provided that the weight percent of any particular component does not fall outside the limits of the range specified for that component.

This disclosure refers to both particles and powders. These two terms are equivalent, except for the caveat that a singular “powder” refers to a collection of particles. The present invention can apply to a wide variety of powders and particles. The terms “nanoparticle” and “nano-sized particle” are generally understood by those of ordinary skill in the art to encompass a particle on the order of nanometers in diameter, typically between about 0.3 nm to 500 nm, about 0.5 nm to 500 nm, about 1 nm to 500 nm, about 1 nm to 100 nm, about 1 nm to 50 nm, about 0.3 nm to about 10 nm, or about 10 nm to about 20 nm. Preferably, the nanoparticles have an average grain size less than 250 nanometers. In some embodiments, the nanoparticles have an average grain size of about 50 nm or less, about 30 nm or less, or about 20 nm or less, or about 10 nm or less, or about 5 nm or less, or about 1 nm or less, or about 0.5 nm or less, or about 0.3 nm or less. In additional embodiments, the nanoparticles have an average diameter of about 50 nm or less, about 30 nm or less, or about 20 nm or less, or about 10 nm or less, or about 5 nm or less, or about 1 nm or less, or about 0.5 nm or less, or about 0.3 nm or less. The aspect ratio of the particles, defined as the longest dimension of the particle divided by the shortest dimension of the particle, is preferably between one and ten, more preferably between one and two, and even more preferably between one and 1.2.

“Grain size” is measured using the ASTM (American Society for Testing and Materials) standard (see ASTM E112-10). When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art. In some embodiments, the nanoparticles have a grain size of about 50 nm or less, about 30 nm or less, or about 20 nm or less, or about 10 nm or less, or about 5 nm or less, or about 1 nm or less, or about 0.5 nm or less, or about 0.3 nm or less. In additional embodiments, the nanoparticles have a diameter of about 50 nm or less, about 30 nm or less, or about 20 nm or less, or about 10 nm or less, or about 5 nm or less, or about 1 nm or less, or about 0.5 nm or less, or about 0.3 nm or less.

The terms “micro-particle,” “micro-sized particle” “micron-particle,” and “micron-sized particle” are generally understood to encompass a particle on the order of micrometers in diameter, such as between about 0.5 μm to 1000 μm, about 1 μm to 1000 μm, about 1 μm to 100 μm, or about 1 μm to 50 μm. Additionally, the term “platinum group metals” (abbreviated “PGM”) used in this disclosure refers to the collective name used for six metallic elements clustered together in the periodic table. The six platinum group metals are ruthenium, rhodium, palladium, osmium, iridium, and platinum.

### Composite Nanoparticle Catalyst

A composite nanoparticle catalyst used to produce NNiM particles includes a catalytic nanoparticle attached to a support nanoparticle to form a “nano-on-nano” composite nanoparticle. In some embodiments, multiple nano-on-nano particles are then embedded within a porous carrier, which may be used to form a catalytic micro-particle. The use of these catalytic micro-particles can reduce requirements for platinum group metal content and/or significantly enhance performance, for example when employed in a catalytic converter, as compared with currently available commercial catalytic converters prepared by wet-chemistry methods. The wet-chemistry methods generally involve use of a solution of platinum group metal ions or metal salts, which are impregnated on already formed supports (typically micron-sized particles), and reduced to platinum group metal in elemental form for use as the catalyst. For example, a solution of chloroplatinic acid, H₂PtCl₆, can be applied to alumina micro-particles, followed by drying and calcining, resulting in precipitation of platinum onto the alumina. The platinum group metals deposited by wet-chemical methods onto metal oxide supports, such as alumina, are mobile at high temperatures, such as temperatures encountered in catalytic converters. That is, at elevated temperatures, the platinum group metal atoms can migrate over the surface on which they are deposited, and will clump together with other PGM atoms. The finely-divided portions of PGM combine into larger and larger agglomerations of platinum group metal as the time of exposure to high temperature increases. This agglomeration leads to reduced catalyst surface area and degrades the performance of the catalytic converter. This phenomenon is referred to as “aging” of the catalytic converter.

In composite nanoparticles produced by plasma synthesis, catalytic platinum group metals generally have much lower mobility than the platinum group metals deposited by wet chemistry methods. The resulting plasma-produced catalysts age at a much slower rate than the wet-chemistry produced catalysts. Thus, catalytic converters using plasma-produced catalysts can maintain a larger surface area of exposed catalyst to gases emitted by the engine over a longer period of time, leading to better emissions performance. The Pt/Pd-alumina composite nanoparticles, when produced under reducing conditions, such as by using argon/hydrogen working gas, or by using argon/hydrogen working gas in the presence of some palladium feed metal, results in a partially reduced alumina surface on the support nanoparticle on which the platinum group metal catalytic nanoparticle is disposed, as described in US 2011/0143915 at paragraphs 0014-0022, the disclosure of which is hereby incorporated by reference in its entirety. The partially reduced alumina surface, or Al₂O₍₃₋ₓ₎ where x is greater than zero, but less than three, inhibits migration of the platinum group metal on the alumina surface at high temperatures. This in turn limits the agglomeration of platinum group metal when the particles are exposed to prolonged elevated temperatures. Such agglomeration is undesirable for many catalytic applications, as it reduces the surface area of platinum group metal catalyst available for reaction.

In one embodiment, the platinum group nano-size catalytic particle is disposed on a nano-sized support particle. In some embodiments, the nano-sized catalytic particle is a platinum group metal, such as platinum, palladium, a platinum/palladium alloy, or rhodium. Although platinum group metals are generally described, all metals are contemplated. Other metals, such as transition metals and poor metals also exhibit catalytic properties. Generally, transition metals comprise scandium, titanium, chromium, vanadium, manganese, iron, cobalt, nickel, copper, zinc, yttrium, zirconium, niobium, molybdenum, cadmium, tantalum, tungsten, and mercury. Poor metals comprise aluminum, germanium, gallium, tin, antimony, lead, indium, tellurium, bismuth and polonium. In some embodiments, the nano-sized catalytic particle comprises an alloy of two or more platinum group metals, such as platinum and palladium. In some embodiments, such as when the nano-sized catalytic particle comprises both platinum and palladium, the metals may be found in any ratio, such as about 1:1 platinum:palladium by weight, about 50:1 platinum:palladium by weight, or about 2:1 platinum:palladium, or about 10:1 platinum:palladium, or about 25:1 platinum:palladium. In some embodiments, the ratio of platinum to palladium may be about 1:50 platinum:palladium, or about 1:25 platinum:palladium, or about 1:10 platinum:palladium, or about 1:2 platinum:palladium. In some embodiments, a single catalytic metal is used, for example platinum but is substantially free of palladium, or palladium but substantially free of platinum.

In some embodiments of composite nanoparticles, one or more nano-sized catalytic particles are disposed on a nano-sized support particle. In embodiments comprising a single nano-sized catalytic particle disposed on the nano-sized support particle, the nano-sized catalytic particle may be a homogenous metal or may be a metal alloy. In embodiments comprising two or more nano-sized catalytic particles, each nano-sized catalytic particle may be a homogenous metal or an alloy, and the nano-sized catalytic particles may be comprised of the same homogenous metal or alloy, or of differing homogenous metals or alloys. In some embodiments, the nano-sized support particle may be an oxide. By way of example, oxides such as alumina (aluminum oxide, Al₂O₃), silica (SiO₂), zirconia (ZrO₂), titania (TiO₂), ceria (cerium oxide, CeO₂), baria (BaO), lanthana (La₂O₃), and yttria (Y₂O₃) may be used. Other useful oxides will be apparent to those of ordinary skill.

In some embodiments, the relative proportion of platinum group metal to support material, such as aluminum oxide, may be a range of about 0.001 wt % to about 50 wt % platinum group metal(s) and about 50 wt % to about 99.999 wt % metal oxide, about 0.001 wt % to about 40 wt % platinum group metal(s) and about 60 wt % to about 99.999 wt % metal oxide, about 0.001 wt % to about 30 wt % platinum group metal(s) and about 70 wt % to about 99.999 wt % metal oxide, about 0.001 wt % to about 20 wt % platinum group metal(s) and about 80 wt % to about 99.999 wt % metal oxide, such as about 0.04 wt % to about 5 wt % platinum group metals and about 95 wt % to about 99.9 wt % aluminum oxide. In some embodiments of composite nanoparticles used in NNiM particles, materials range from about 0 wt % to about 20 wt % platinum, about 0 wt % to about 20 wt % palladium, and about 80 wt % to about 99.999 wt % aluminum oxide; in further embodiments, from about 0.5 wt % to about 1.5 wt % platinum, about 0.01 wt % to about 0.1 wt % palladium, and about 97.9 wt % to about 99.1 wt %; in still further embodiments, from about 0.5 wt % to about 1.5 wt % platinum, about 0.1 wt % to about 0.3 wt % palladium, and about 98.2 wt % to about 99.4 wt % aluminum oxide. An exemplary composite nano-on-nano particle used in NNiM particles comprises about 0.952 wt % platinum, about 0.048 wt % palladium, and about 99 wt % aluminum oxide; or about 0.83 wt % platinum, about 0.17 wt % palladium, and about 99 wt % aluminum oxide.

In some embodiments, the relative proportion of platinum group metal (such as platinum, palladium, platinum/palladium alloy, or rhodium) to support material, such as cerium oxide, may be a range of about 0.001 wt % to about 50 wt % platinum group metal(s) and about 50 wt % to about 99.999 wt % metal oxide, about 0.001 wt % to about 40 wt % platinum group metal(s) and about 60 wt % to about 99.999 wt % metal oxide, about 0.001 wt % to about 30 wt % platinum group metal(s) and about 70 wt % to about 99.999 wt % metal oxide, about 0.001 wt % to about 20 wt % platinum group metal(s) and about 80 wt % to about 99.999 wt % metal oxide, such as about 0.04 wt % to about 5 wt % platinum group metal(s) and about 95 wt % to about 99.9 wt % cerium oxide. In some embodiments of composite nanoparticles used in NNiM particles, materials range from about 0 wt % to about 20 wt % platinum, about 0 wt % to about 20 wt % palladium, and about 80 wt % to about 99.999 wt % cerium oxide; in further embodiments, from about 0.5 wt % to about 1.5 wt % platinum, about 0.01 wt % to about 0.1 wt % palladium, and about 97.9 wt % to about 99.1 wt %; in still further embodiments, from about 0.5 wt % to about 1.5 wt % platinum, about 0.1 wt % to about 0.3 wt % palladium, and about 98.2 wt % to about 99.4 wt % cerium oxide. An exemplary composite nano-on-nano particle used in NNiM particles comprises about 0.952 wt % platinum, about 0.048 wt % palladium, and about 99 wt % cerium oxide; or about 0.83 wt % platinum, about 0.17 wt % palladium, and about 99 wt % cerium oxide. In some embodiments of composite nanoparticles used in NNiM particles, materials range from about 0.001 wt % to about 50 wt % rhodium and about 50 wt % to about 99.999 wt % cerium oxide, about 0.001 wt % to about 40 wt % rhodium and about 60 wt % to about 99.999 wt % cerium oxide, about 0.001 wt % to about 30 wt % rhodium and about 70 wt % to about 99.999 wt % cerium oxide, about 0 wt % to about 20 wt % rhodium and about 80 wt % to about 99.999 wt % cerium oxide; in further embodiments, from about 0.5 wt % to about 10 wt % rhodium and about 90 wt % to about 99.5 wt % cerium oxide; in still further embodiments, from about 0.5 wt % to about 2 wt % rhodium, and about 98 wt % to about 99.5 wt % cerium oxide. An exemplary composite nano-on-nano particle used in NNiM particles comprises about 0.952 wt % platinum, about 0.048 wt % palladium, and about 99 wt % cerium oxide; or about 0.83 wt % platinum, about 0.17 wt % palladium, and about 99 wt % cerium oxide. Another exemplary composite nano-on-nano particle used in NNiM particles comprises about 3 wt % rhodium and about 97 wt % cerium oxide. In any of the foregoing embodiments, the cerium oxide support material can be replaced by cerium-zirconium oxide, cerium-zirconium-lanthanum oxide, or cerium-zirconium-lanthanum-yttrium oxide as support material. When cerium-zirconium oxide is used as the support material, it can have a composition of from about 10 wt % to 70 wt % zirconium oxide and about 30 wt % cerium oxide to 90 wt % cerium oxide, such as about 10 wt % to 55 wt % zirconium oxide and about 45 wt % cerium oxide to 90 wt % cerium oxide, about 10 wt % to 45 wt % zirconium oxide and about 55 wt % cerium oxide to 90 wt % cerium oxide, about 10 wt % to 30 wt % zirconium oxide and about 70 wt % cerium oxide to 90 wt % cerium oxide, or about 15 wt % to 25 wt % zirconium oxide and about 75 wt % cerium oxide to 85 wt % cerium oxide; in one embodiment, the cerium-zirconium oxide is about 20 wt % zirconium oxide and about 80 wt % cerium oxide. When cerium-zirconium-lanthanum oxide is used as the support material, it can have a composition of from about 5 wt % to 30 wt % zirconium oxide, about 5 wt % to 30 wt % lanthanum oxide, and about 40 wt % to 90 wt % cerium oxide, such as about 5 wt % to 20 wt % zirconium oxide, about 5 wt % to 20 wt % lanthanum oxide, and about 60 wt % to 90 wt % cerium oxide, about 5 wt % to 30 wt % zirconium oxide, about 5 wt % to 10 wt % lanthanum oxide, and about 60 wt % to 90 wt % cerium oxide, about 5 wt % to 20 wt % zirconium oxide, about 5 wt % to 10 wt % lanthanum oxide, and about 70 wt % to 90 wt % cerium oxide, about 5 wt % to 15 wt % zirconium oxide, about 3 wt % to 7 wt % lanthanum oxide, and about 78 wt % to 92 wt % cerium oxide; in one embodiment, the cerium-zirconium-lanthanum oxide is about 10 wt % zirconium oxide, about 4 wt % lanthanum oxide, and about 86 wt % cerium oxide. When cerium-zirconium-lanthanum-yttrium oxide is used as the support material, it can have a composition of from about 3 wt % to 30 wt % zirconium oxide, about 3 wt % to 20 wt % lanthanum oxide, about 3 wt % to 20 wt % yttrium oxide, and about 30 wt % to 91 wt % cerium oxide, about 5 wt % to 15 wt % zirconium oxide, about 2.5 wt % to 7.5 wt % lanthanum oxide, about 2.5 wt % to 7.5 wt % yttrium oxide, and about 70 wt % to 90 wt % cerium oxide; in one embodiment, the cerium-zirconium-lanthanum-yttrium oxide is about 10 wt % zirconium oxide, about 5 wt % lanthanum oxide, about 5 wt % yttrium oxide, and about 80 wt % cerium oxide.

In some embodiments, the catalytic nanoparticles have an average diameter or average grain size between about 0.3 nm and about 10 nm, such as between about 1 nm to about 5 nm, that is, about 3 nm+/−2 nm. In some embodiments, the catalytic nanoparticles have an average diameter or average grain size between approximately 0.3 nm to approximately 1 nm, while in other embodiments, the catalytic nano-particles have an average diameter or average grain size between approximately 1 nm to approximately 5 nm, while in other embodiments, the catalytic nanoparticles have an average diameter or average grain size between approximately 5 nm to approximately 10 nm. In some embodiments, the support nanoparticles, such as those comprising a metal oxide, for example aluminum oxide, cerium oxide, cerium-zirconium oxide, cerium-zirconium-lanthanum oxide, or cerium-zirconium-lanthanum-yttrium oxide, have an average diameter of about 20 nm or less; or about 15 nm or less; or about 10 nm or less; or about 5 nm or less; or about 2 nm or less; or between about 2 nm and about 5 nm, that is, 3.5 nm+/−1.5 nm; or between 2 nm and about 10 nm, that is 6 nm+/−4 nm; or between about 10 nm and about 20 nm, that is, about 15 nm+/−5 nm; or between about 10 nm and about 15 nm, that is, about 12.5 nm+/−2.5 nm. In some embodiments, the composite nanoparticles have an average diameter or average grain size of about 2 nm to about 20 nm, that is 11 nm+/−9 nm; or about 4 nm to about 18 nm, that is 11+/−7 nm; or about 6 nm to about 16 nm, that is 11+/−5 nm; or about 8 nm to about 14 nm, that is about 11 nm+/−3 nm; or about 10 nm to about 12 nm, that is about 11+/−1 nm; or about 10 nm; or about 11 nm; or about 1 nm.

The composite nanoparticles comprising two or more nanoparticles (catalytic or support) may be referred to as “nano-on-nano” particles or “NN” particles.

### Production of Composite Nanoparticles by Plasma-Based Methods (“Nano-on-Nano” Particles or “NN” Particles)

The initial step in producing suitable catalysts involves producing composite nanoparticles. The composite nanoparticles comprise one or more catalytic nanoparticles, and one or more support nanoparticles. Preferably, the catalytic nanoparticle comprises one or more platinum group metals, such as rhodium, platinum, palladium, or a platinum/palladium alloy, and the support nanoparticle is a metal oxide, such as aluminum oxide or cerium oxide, or cerium-zirconium oxide, cerium-zirconium-lanthanum oxide, or cerium-zirconium-lanthanum-yttrium oxide. As the name “nanoparticle” implies, the nanoparticles have sizes on the order of nanometers.

The composite nanoparticles may be formed by plasma reactor methods, by feeding one or more catalytic materials, such as a platinum group metal(s), and one or more support materials, such as a metal oxide, into a plasma gun, where the materials are vaporized. The high-throughput particle production system described in US 2014/0263190 and International Patent Appl. No. PCT/US2014/02493 can be used to produce the composite nanoparticles. Other equipment suitable for plasma synthesis is disclosed in U.S. Patent Application Publication No. 2008/0277267 and U.S. Pat. No. 8,663,571. Plasma guns such as those disclosed in US 2011/0143041 can be used, and techniques such as those disclosed in U.S. Pat. No. 5,989,648, U.S. Pat. No. 6,689,192, U.S. Pat. No. 6,755,886, and US 2005/0233380 can be used to generate plasma. A working gas, such as argon, is supplied to the plasma gun for the generation of plasma; in one embodiment, an argon/hydrogen mixture (in the ratio of 10:1 Ar/H₂) is used as the working gas. In one embodiment, one or more platinum group metals, such as rhodium, platinum, palladium, or a mixture of platinum and palladium, which are generally in the form of metal particles of about 0.5 to 6 microns in diameter, can be introduced into the plasma reactor as a fluidized powder in a carrier gas stream such as argon. In some embodiments two or more platinum group metals may be added, such as a mixture of platinum and palladium, in any ratio, such as about 1:1 platinum:palladium by weight to about 50:1 platinum:palladium by weight, or about 2:1 platinum:palladium, or about 10:1 platinum:palladium, or about 25:1 platinum:palladium. Support material, for example a metal oxide, typically aluminum oxide or cerium oxide, or a mixture of cerium oxide and zirconium oxide, cerium oxide, zirconium oxide and lanthanum oxide, or cerium oxide, zirconium oxide, lanthanum oxide, and yttrium oxide, in a particle size of about 15 to 25 microns diameter, is also introduced as a fluidized powder in carrier gas. In some embodiments, the material composition preferably has a range of about 0.001 wt % to about 20 wt % platinum group metals and about 80 wt % to about 99.999 wt % aluminum oxide, and even more preferably about 0.04 wt % to about 5 wt % platinum group metals and about 95 wt % to about 99.9 wt % aluminum oxide. Example ranges of materials that can be used to form composite nanoparticles are from about 0 wt % to about 20 wt % platinum, about 0 wt % to about 20 wt % palladium, and about 80 wt % to about 99.999 wt % aluminum oxide; in some embodiments, from about 0.5 wt % to about 1.5 wt % platinum, about 0.01 wt % to about 0.1 wt % palladium, and about 97.9 wt % to about 99.1 wt % aluminum oxide; in further embodiments, from about 0.5 wt % to about 1.5 wt % platinum, about 0.1 wt % to about 0.3 wt % palladium, and about 98.2 wt % to about 99.4 wt % aluminum oxide. An exemplary composition useful for forming composite nano-on-nano particles used in NNiM particles comprises about 0.952 wt % platinum, about 0.048 wt % palladium, and about 99 wt % aluminum oxide; or about 0.83 wt % platinum, about 0.17 wt % palladium, and about 99 wt % aluminum oxide. In other embodiments, the material composition preferably has a range of about 0.001 wt % to about 20 wt % platinum group metals and about 80 wt % to about 99.999 wt % cerium oxide, and even more preferably about 0.04 wt % to about 5 wt % platinum group metals and about 95 wt % to about 99.9 wt % cerium oxide. Example ranges of materials that can be used to form composite nanoparticles are from about 0 wt % to about 20 wt % platinum, about 0 wt % to about 20 wt % palladium, and about 80 wt % to about 99.999 wt % cerium oxide; in some embodiments, from about 0.5 wt % to about 1.5 wt % platinum, about 0.01 wt % to about 0.1 wt % palladium, and about 97.9 wt % to about 99.1 wt % cerium oxide; in further embodiments, from about 0.5 wt % to about 1.5 wt % platinum, about 0.1 wt % to about 0.3 wt % palladium, and about 98.2 wt % to about 99.4 wt % cerium oxide. Another exemplary composition useful for forming composite nano-on-nano particle used in NNiM particles comprises about 0.952 wt % platinum, about 0.048 wt % palladium, and about 99 wt % cerium oxide; or about 0.83 wt % platinum, about 0.17 wt % palladium, and about 99 wt % cerium oxide. In yet other embodiments, the material composition preferably has a range of about 0.001 wt % to about 50 wt % rhodium and about 50 wt % to about 99.999 wt % cerium oxide, of about 0.001 wt % to about 40 wt % rhodium and about 60 wt % to about 99.999 wt % cerium oxide, of about 0.001 wt % to about 30 wt % rhodium and about 70 wt % to about 99.999 wt % cerium oxide, of about 0.001 wt % to about 20 wt % rhodium and about 80 wt % to about 99.999 wt % cerium oxide, or from about 0.04 wt % to about 5 wt % rhodium and about 95 wt % to about 99.9 wt % cerium oxide. Example ranges of materials that can be used to form composite nanoparticles are from about 0.001 wt % to about 20 wt % rhodium and about 80 wt % to about 99.999 wt % cerium oxide; in some embodiments, from about 0.5 wt % to about 5 wt % rhodium, and about 95 wt % to about 99.5 wt % cerium oxide; or from about 0.5 wt % to about 1.5 wt % rhodium, and about 98.5 wt % to about 99.5 wt % cerium oxide. Another exemplary composition useful for forming composite nano-on-nano particle used in NNiM particles comprises about 0.952 wt % platinum, about 0.048 wt % palladium, and about 99 wt % cerium oxide; or about 0.83 wt % platinum, about 0.17 wt % palladium, and about 99 wt % cerium oxide. In any of the preceding embodiments, cerium-zirconium oxide, cerium-zirconium-lanthanum oxide, or cerium-zirconium-lathanum-yttrium oxide can be used in place of cerium oxide.

Other methods of introducing the materials into the reactor can be used, such as in a liquid slurry. Any solid or liquid materials are rapidly vaporized or turned into plasma. The kinetic energy of the superheated material, which can reach temperatures of 20,000 to 30,000 Kelvin, ensures extremely thorough mixing of all components.

The superheated material of the plasma stream is then quenched rapidly, using such methods as the turbulent quench chamber disclosed in US 2008/0277267. Argon quench gas at high flow rates, such as 2400 to 2600 liters per minute, is injected into the superheated material. The material is further cooled in a cool-down tube, and collected and analyzed to ensure proper size ranges of material.

The plasma production method described above produces uniform composite nanoparticles, where the composite nanoparticles comprise a catalytic nanoparticle disposed on a support nanoparticle. The catalytic nanoparticle comprises the platinum group metal or metals, such as Pt:Pd in a 1:1 ratio by weight, or a 2:1 ratio by weight, or a 10:1 ratio by weight, or a 25:1 ratio by weight, or a 50:1 ratio by weight. In other embodiments, the ratio of platinum to palladium may be about 1:50 platinum:palladium, or about 1:25 platinum:palladium, or about 1:10 platinum:palladium, or about 1:2 platinum:palladium.

### Porous Materials

Generally, a preferred porous material is a material that contains a large number of interconnected pores, holes, channels, or pits, with an average pore, hole, channel, or pit width (diameter) ranging from 1 nm to about 200 nm, or about 1 nm to about 100 nm, or about 2 nm to about 50 nm, or about 3 nm to about 25 nm. In some embodiments, the porous material has a mean pore, hole, channel, or pit width (diameter) of less than about 1 nm, while in some embodiments, a porous carrier has a mean pore, hole, channel, or pit width (diameter) of greater than about 100 nm. In some embodiments, the porous material has an average pore surface area in a range of about 50 m²/g to about 500 m²/g. In some embodiments, the porous material has an average pore surface area in a range of about 100 m²/g to about 400 m²/g. In some embodiments, a porous material has an average pore surface area in a range of about 150 m²/g to about 300 m²/g. In some embodiments, the porous material has an average pore surface area of less than about 50 m²/g. In some embodiments, the porous material has an average pore surface area of greater than about 200 m²/g. In some embodiments, the porous material has an average pore surface area of greater than about 300 m²/g. In some embodiments, a porous material has an average pore surface area of about 200 m²/g. In some embodiments, a porous material has an average pore surface area of about 300 m²/g.

In some embodiments, the porous material may comprise porous metal oxide, such as aluminum oxide. In some embodiments, a porous material may comprise an organic polymer, such as polymerized resorcinol. In some embodiments, the porous material may comprise amorphous carbon. In some embodiments, the porous material may comprise silica. In some embodiments, a porous material may be porous ceramic. In some embodiments, the porous material may comprise a mixture of two or more different types of interspersed porous materials, for example, a mixture of aluminum oxide and polymerized resorcinol. In some embodiments, the porous carrier may comprise aluminum oxide after a spacer material has been removed. For example, in some embodiments, a composite material may be formed with interspersed aluminum oxide and polymerized resorcinol, and the polymerized resorcinol is removed, for example, by calcination, resulting in a porous carrier. In another embodiment, a composite material may be formed with interspersed aluminum oxide and carbon black, and the carbon black is removed, for example, by calcination, resulting in a porous carrier. In other embodiments, the porous material may comprise a porous metal oxide comprising cerium oxide. In some embodiments, the porous material may comprise a mixture of two or more different types of interspersed porous materials, for example, a mixture of cerium oxide and polymerized resorcinol, cerium oxide and amorphous carbon, cerium oxide and silica, or cerium oxide and porous ceramic. In some embodiments, the porous carrier may comprise cerium oxide after a spacer material has been removed. For example, in some embodiments, a composite material may be formed with interspersed cerium oxide and polymerized resorcinol, and the polymerized resorcinol is removed, for example, by calcination, resulting in a porous carrier. In another embodiment, a composite material may be formed with interspersed cerium oxide and carbon black, and the carbon black is removed, for example, by calcination, resulting in a porous carrier. In any of the preceding embodiments, cerium-zirconium oxide, cerium-zirconium-lanthanum oxide, or cerium-zirconium-lathanum-yttrium oxide can be used in place of cerium oxide.

In some embodiments, the porous material is a micron-sized particle, with an average size between about 1 micron and about 100 microns, between about 1 micron and about 10 microns, between about 3 microns and about 7 microns, or between about 4 microns and about 6 microns. In other embodiments, the porous material may be particles larger than about 7 microns. In some embodiments, the porous material may not be in the form of particles, but a continuous material.

The porous materials may allow gases and fluids to slowly flow throughout the porous material via the interconnected channels, being exposed to the high surface area of the porous material. The porous materials can therefore serve as an excellent carrier material for embedding particles in which high surface area exposure is desirable, such as catalytic nanoparticles, as described below.

### Production of Porous Materials

A catalyst is formed using a porous material. Porous materials include, for example, catalyst particles embedded within the porous structure of the material. In some embodiments the porous structure comprises alumina. In some embodiments the porous structure comprises ceria. In other embodiments, the porous structure comprises cerium-zirconium oxide, cerium-zirconium-lanthanum oxide, or cerium-zirconium-lanthanum-yttrium oxide. Alumina porous structures may be formed, for example, by the methods described in U.S. Pat. No. 3,520,654, the disclosure of which is hereby incorporated by reference in its entirety. In some embodiments, a sodium aluminate solution, prepared by dissolving sodium oxide and aluminum oxide in water, can be treated with sulfuric acid or aluminum sulfate to reduce the pH to a range of about 4.5 to about 7. The decrease in pH results in a precipitation of porous hydrous alumina which may be spray dried, washed, and flash dried, resulting in a porous alumina material. Optionally, the porous alumina material may be stabilized with silica, as described in EP0105435 A2, the disclosure of which is hereby incorporated by reference in its entirety. A sodium aluminate solution can be added to an aluminum sulfate solution, forming a mixture with a pH of about 8.0. An alkaline metal silicate solution, such as a sodium silicate solution, can be slowly added to the mixture, resulting in the precipitation of a silica-stabilized porous alumina material.

A porous material may also be generated by co-precipitating aluminum oxide nanoparticles and amorphous carbon particles, such as carbon black. Upon drying and calcination of the precipitate in an ambient or oxygenated environment, the amorphous carbon is exhausted, that is, burned off. Simultaneously, the heat from the calcination process causes the aluminum oxide nanoparticles to sinter together, resulting in pores throughout the precipitated aluminum oxide where the carbon black once appeared in the structure. In some embodiments, aluminum oxide nanoparticles can be suspended in ethanol, water, or a mix of ethanol and water. In some embodiments, dispersant, such as DisperBYK®-145 from BYK (DisperBYK is a registered trademark of BYK-Chemie GmbH LLC, Wesel, Germany for chemicals for use as dispersing and wetting agents) may be added to the aluminum oxide nanoparticle suspension. Carbon black with an average grain size ranging from about 1 nm to about 200 nm, or about 20 nm to about 100 nm, or about 20 nm to about 50 nm, or about 35 nm, may be added to the aluminum oxide suspension. In some embodiments, sufficient carbon black is added to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. The pH of the resulting mixture can be adjusted to a range of about 2 to about 7, such as a pH of between about 3 and about 5, preferably a pH of about 4, allowing the particles to precipitate. In some embodiments, the precipitant can be dried, for example by warming the precipitant (for example, at about 30° C. to about 95° C., preferably about 60° C. to about 70° C., at atmospheric pressure or at reduced pressure such as from about 1 pascal to about 90,000 pascal). Alternatively, in some embodiments, the precipitant may be freeze-dried.

After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the aluminum oxide nanoparticles sinter together, yielding a porous aluminum oxide material.

In other embodiments, a porous material may also be generated by co-precipitating cerium oxide nanoparticles and amorphous carbon particles, such as carbon black. Upon drying and calcination of the precipitate in an ambient or oxygenated environment, the amorphous carbon is exhausted, that is, burned off. Simultaneously, the heat from the calcination process causes the cerium oxide nanoparticles to sinter together, resulting in pores throughout the precipitated cerium oxide where the carbon black once appeared in the structure. In some embodiments, cerium oxide nanoparticles can be suspended in ethanol, water, or a mix of ethanol and water. In some embodiments, dispersant, such as DisperBYK®-145 from BYK (DisperBYK is a registered trademark of BYK-Chemie GmbH LLC, Wesel, Germany for chemicals for use as dispersing and wetting agents) may be added to the cerium oxide nanoparticle suspension. Carbon black with an average grain size ranging from about 1 nm to about 200 nm, or about 20 nm to about 100 nm, or about 20 nm to about 50 nm, or about 35 nm, may be added to the cerium oxide suspension. In some embodiments, sufficient carbon black is added to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. The pH of the resulting mixture can be adjusted to a range of about 2 to about 7, such as a pH of between about 3 and about 5, preferably a pH of about 4, allowing the particles to precipitate. In some embodiments, the precipitant can be dried, for example by warming the precipitant (for example, at about 30° C. to about 95° C., preferably about 60° C. to about 70° C., at atmospheric pressure or at reduced pressure such as from about 1 pascal to about 90,000 pascal). Alternatively, in some embodiments, the precipitant may be freeze-dried.

After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the cerium oxide nanoparticles sinter together, yielding a porous cerium oxide material.

In some embodiments, a porous material may be made using the sol-gel process. For example, a sol-gel precursor to an alumina porous material may be formed by reacting aluminum chloride with propylene oxide. Propylene oxide can be added to a solution of aluminum chloride dissolved in a mixture of ethanol and water, which forms a porous material that may be dried and calcined. In some embodiments, epichlorodydrin may be used in place of propylene oxide. As another example, a sol-gel precursor to a ceria porous material may be formed by reacting cerium nitrate with resorcinol and formaldehyde. Other methods of producing a porous material using the sol-gel method known in the art may also be used, for example, a porous material formed using the sol-gel process may be also be formed using tetraethyl orthosilicate.

In some embodiments, the porous material may be formed by mixing the precursors of a combustible gel with the precursors of a metal oxide material prior to polymerization of the gel, allowing the polymerization of the gel, drying the composite material, and calcining the composite material, thereby exhausting the organic gel components. In some embodiments, a gel activation solution comprising a mixture of formaldehyde and propylene oxide can be mixed with a gel monomer solution comprising a mixture of aluminum chloride and resorcinol. Upon mixing of the gel activation solution and the gel monomer solution, a combustible organic gel component forms as a result of the mixing of formaldehyde and resorcinol, and a non-combustible inorganic metal oxide material forms as a result of mixing the propylene oxide and aluminum chloride. The resulting composite material can be dried and calcined, causing the combustible organic gel component to burn away, resulting in a porous metal oxide material (aluminum oxide). In another embodiment, a solution of formaldehyde can be reacted with a solution of resorcinol and cerium nitrate. The resulting material can be dried and calcined, causing the combustible organic gel component to burn away, resulting in a porous metal oxide material (cerium oxide). The resulting material can be dried and calcined, causing the combustible organic gel component to burn away, resulting in a porous metal oxide material (cerium oxide). In yet further embodiments, a solution of formaldehyde can be reacted with a solution of resorcinol, cerium nitrate, and one or more of zirconium oxynitrate, lanthanum acetate, and/or yttrium nitrate as appropriate to form cerium-zirconium oxide, cerium-zirconium-lanthanum oxide, or cerium-zirconium-lanthanum-yttrium oxide. The resulting material can be dried and calcined, causing the combustible organic gel component to burn away, resulting in a porous metal oxide material (cerium-zirconium oxide, cerium-zirconium-lanthanum oxide, or cerium-zirconium-lanthanum-yttrium oxide).

In some embodiments, the gel activation solution may be prepared by mixing aqueous formaldehyde and propylene oxide. The formaldehyde is preferably in an aqueous solution. In some embodiments, the concentration of the aqueous formaldehyde solution is about 5 wt % to about 50 wt % formaldehyde, about 20 wt % to about 40 wt % formaldehyde, or about 30 wt % to about 40 wt % formaldehyde. Preferably, the aqueous formaldehyde is about 37 wt % formaldehyde. In some embodiments, the aqueous formaldehyde may contain about 5 wt % to about 15 wt % methanol to stabilize the formaldehyde in solution. The aqueous formaldehyde can be added in a range of about 25% to about 50% of the final weight of the gel activation solution, with the remainder being propylene oxide. Preferably, the gel activation solution comprises 37.5 wt % of the aqueous formaldehyde solution (which itself comprises 37 wt % formaldehyde) and 62.5 wt % propylene oxide, resulting in a final formaldehyde concentration of about 14 wt % of the final gel activation solution.

Separately from the gel activation solution, a gel monomer solution may be produced by dissolving aluminum chloride in a mixture of resorcinol and ethanol. Resorcinol can be added at a range of about 2 wt % to about 10 wt %, with about 5 wt % being a typical value. Aluminum chloride can be added at a range of about 0.8 wt % to about 5 wt %, with about 1.6 wt % being a typical value.

The gel activation solution and gel monomer solution can be mixed together at a ratio at about 1:1 in terms of (weight of gel activation solution):(weight of gel monomer solution). The final mixture may then be dried (for example, at about 30° C. to about 95° C., preferably about 50° C. to about 60° C., at atmospheric pressure or at reduced pressure such as from about 1 pascal to about 90,000 pascal, for about one day to about 5 days, or for about 2 days to about 3 days). After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere, for about 12 hours to about 2 days, or about 16 hours to about 24 hours) to burn off the combustible organic gel component and yield a porous aluminum oxide carrier.

Gel monomer solutions can be prepared with cerium nitrate, zirconium oxynitrate, lanthanum acetate, and/or yttrium nitrate in a process similar to that described above, for preparation of porous cerium oxide, cerium-zirconium oxide, cerium-zirconium-lanthanum oxide, or cerium-zirconium-lanthanum-yttrium oxide carrier.

Micron-Sized Particles Comprising Composite Nanoparticles Embedded within a Porous Carrier (“Nano-on-Nano-in-Micro” Particles or “NNiM” Particles)

Nanoparticles or composite nanoparticles produced by plasma production or other methods are be embedded within a porous material to enhance the surface area of catalytic components. The porous material may then serve as a carrier for the composite nanoparticles, allowing gases and fluids to slowly flow throughout the porous material via the interconnected channels. The high porosity of the carrier results in a high surface area within the carrier allowing increased contact of the gases and fluids with the embedded catalytic components, such as composite nanoparticles. Embedding the composite nanoparticles within the porous carrier results in a distinct advantage over those technologies where catalytically active nanoparticles are positioned on the surface of carrier micro-particles or do not penetrate as effectively into the pores of the support. When catalytically active nanoparticles are positioned on the surface of carrier micro-particles, some catalytically active nanoparticles can become buried by other catalytically active nanoparticles, causing them to be inaccessible to target gases because of the limited exposed surface area. When the composite nanoparticles are embedded within the porous carrier formed around the composite nanoparticles as described herein, however, gases can flow through the pores of the carrier to contact the catalytically active components.

The porous carrier may contain any large number of interconnected pores, holes, channels, or pits, preferably with an average pore, hole, channel, or pit width (diameter) ranging from 1 nm to about 200 nm, or about 1 nm to about 100 nm, or about 2 nm to about 50 nm, or about 3 nm to about 25 nm. In some embodiments, the porous carrier has a mean pore, hole, channel, or pit width (diameter) of less than about 1 nm, while in some embodiments, a porous carrier has a mean pore, hole, channel, or pit width (diameter) of greater than about 100 nm. In some embodiments, a porous material has an average pore surface area in a range of about 50 m²/g to about 500 m²/g. In some embodiments, a porous material has an average pore surface area in a range of about 100 m²/g to about 400 m²/g. In some embodiments, a porous material has an average pore surface area in a range of about 150 m²/g to about 300 m²/g. In some embodiments, a porous material has an average pore surface area of less than about 50 m²/g. In some embodiments, a porous material has an average pore surface area of greater than about 200 m²/g. In some embodiments, a porous material has an average pore surface area of greater than about 300 m²/g. In some embodiments, a porous material has an average pore surface area of about 200 m²/g. In some embodiments, a porous material has an average pore surface area of about 300 m²/g.

A porous carrier embedded with nanoparticles can be formed with any porous material, or any precursor that reacts to form a porous material, and can contain any type of nano-particle. A porous carrier may include, but is not limited to, any gel produced by the sol-gel method, for example, alumina (Al₂O₃), ceria (CeO₂), cerium-zirconium oxide, cerium-zirconium-lanthanum oxide, cerium-zirconium-lanthanum-yttrium oxide, or silica aerogels as described herein. In some embodiments, the porous carrier may comprise a porous metal oxide, such as aluminum oxide, cerium oxide, cerium-zirconium oxide, cerium-zirconium-lanthanum oxide, or cerium-zirconium-lanthanum-yttrium oxide. In some embodiments, a porous carrier may comprise an organic polymer, such as polymerized resorcinol. In some embodiments, the porous carrier may comprise amorphous carbon. In an some embodiments, the porous carrier may comprise silica. In some embodiments, a porous carrier may be porous ceramic. In some embodiments, the porous carrier may comprise a mixture of two or more different types of interspersed porous materials, for example, a mixture of aluminum oxide and polymerized resorcinol, or a mixture of cerium oxide and polymerized resorcinol, or a mixture of cerium-zirconium oxide and polymerized resorcinol, or a mixture of cerium-zirconium-lanthanum oxide and polymerized resorcinol, or a mixture of cerium-zirconium-lanthanum-yttrium oxide and polymerized resorcinol.

In some embodiments, a carrier may comprise a combustible component, for example amorphous carbon or a polymerized organic gel such as polymerized resorcinol, and a non-combustible component, for example a metal oxide such as aluminum oxide, cerium oxide, cerium-zirconium oxide, cerium-zirconium-lanthanum oxide, or cerium-zirconium-lanthanum-yttrium oxide. A catalytic material can include composite nanoparticles embedded in a carrier comprising a combustible component and a non-combustible component.

Catalytic particles, such as the catalytic nanoparticles or catalytic composite nanoparticles described herein are embedded within the porous carrier. This can be accomplished by including the catalytic particles in the mixture used to form the porous carrier. In one embodiment, nano-particles or nano-on-nano particles are mixed into the gel monomer solution prior to addition of the gel activation solution, and the resulting gel will then have the nano-particles or nano-on-nano particles embedded in it. Drying, calcining, and milling results in micron-sized particles comprising composite nanoparticles embedded within a porous carrier (“nano-on-nano-in-micro” particles or “NNiM” particles). In this embodiment, the porous carrier has been formed around the composite nanoparticles. In some embodiments, the catalytic particles are evenly distributed throughout the porous carrier. In other embodiments, the catalytic particles are clustered throughout the porous carrier. In some embodiments, platinum group metals, such as rhodium, platinum, palladium, or platinum/palladium alloy, comprise about 0.001 wt % to about 10 wt % of the total catalytic material (catalytic particles and porous carrier). For example, platinum group metals may comprise about 1 wt % to about 8 wt % of the total catalytic material (catalytic particles and porous carrier). In some embodiments, platinum group metals may comprise less than about 10 wt %, less than about 8 wt %, less than about 6 wt %, less than about 4 wt %, less than about 2 wt %, or less than about 1 wt % of the total catalytic material (catalytic particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total catalytic material (catalytic particles and porous carrier).

In some embodiments, the catalytic nanoparticles comprise one or more platinum group metals, such as rhodium, platinum, palladium, or platinum/palladium alloy. In embodiments with two or more platinum group metals, the metals may be in any ratio. In some embodiments, the catalytic nanoparticles comprise platinum group metal or metals, such as Pt:Pd in about a 1:1 ratio to about 50:1 ratio by weight, or about 1:1 to about 25:1 ratio by weight, or about 1:1 to about 10:1 ratio by weight, or about 1:1 to about 5:1 ratio by weight. In some embodiments the catalytic nanoparticles comprise platinum group metal or metals, such as Pt:Pd in about 5:1 to about 50:1 ratio by weight, or about 5:1 to about 25:1 ratio by weight, or about 5:1 to about 10:1 ratio by weight. In some embodiments, the catalytic nanoparticles comprise platinum group metal or metals, such as Pt:Pd in about 10:1 ratio to about 50:1 ratio by weight, or about 10:1 to about 25:1 ratio by weight. In some embodiments, the catalytic nanoparticles comprise platinum group metal or metals, such as Pt:Pd in about 1:1 ratio by weight, or a 2:1 ratio by weight, or a 5:1 ratio by weight, or a 10:1 ratio by weight, or a 25:1 ratio by weight, or a 50:1 ratio by weight. In other embodiments, the ratio of platinum to palladium may be about 1:50 by weight, or about 1:25 platinum:palladium, or about 1:10 platinum:palladium, or about 1:5 platinum:palladium, or about 1:2 platinum:palladium. In some embodiments, the catalytic nanoparticles comprise platinum but is substantially free of palladium, while in other embodiments, the catalytic nanoparticles comprise palladium but is substantially free of platinum.

The composite nanoparticles (nano-on-nano particles) embedded within a porous carrier by the methods described herein may take the form of a powder to produce composite catalytic micro-particles, referred to as “nano-on-nano-in-micron” particles or “NNiM” particles. The micron-sized NNiM particles can have an average size between about 1 micron and about 100 microns, such as between about 1 micron and about 10 microns, between about 3 microns and about 7 microns, or between about 4 microns and about 6 microns. The NNiM particles may comprise about 0.001 wt % to about 10 wt % of the total mass of the NNiM particle (catalytic particles and porous carrier). For example, platinum group metals, such as rhodium, platinum, palladium, or platinum/palladium alloy, may comprise about 1 wt % to about 8 wt % of the total mass of the NNiM particle (catalytic particles and porous carrier). In some embodiments, platinum group metals may comprise less than about 10 wt %, less than about 8 wt %, less than about 6 wt %, less than about 4 wt %, less than about 2 wt %, or less than about 1 wt % of the total mass of the NNiM particle (catalytic particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total mass of the NNiM particle (catalytic particles and porous carrier).

NNiM particles may be used for any catalytic purpose. For example, NNiM particles may be suspended in a liquid, for example ethanol or water, which may catalyze dissolved compounds. Alternatively, the NNiM particles may be used as a solid state catalyst. For example, the NNiM particles can then be used in catalytic converters.

Production of Micron-Sized Particles Comprising Composite Nanoparticles Embedded within a Porous Carrier (“Nano-on-Nano-in-Micro” Particles or “NNiM” Particles)

In some embodiments, catalytic nanoparticles or composite nanoparticles can be embedded in a porous carrier by forming a suspension or colloid of nanoparticles, and mixing the suspension or colloid of nanoparticles with a porous material precursor solution. Upon solidification of the porous material with the mixture, such as by polymerization, precipitation, or freeze-drying, the porous material will form around the nanoparticles, resulting in a catalytic material comprising nanoparticles embedded in a porous carrier, which in some embodiments can then be dried and calcined. In some embodiments, the catalytic material is then processed, such as by grinding or milling, into a micron-sized powder, resulting in NNiM particles.

Described below is the production of NNiM particles using a porous aluminum oxide carrier formed using a composite carrier comprising a combustible organic gel component and an aluminum oxide component, followed by drying and calcination. However, one skilled in the art would understand any manner of porous carrier originating from soluble precursors may be used to produce catalytic material comprising composite nanoparticles embedded within a porous carrier using the methods described herein.

For typical NNiM particles produced using a porous aluminum oxide carrier formed using a composite carrier comprising a combustible organic gel component and an aluminum oxide component, the composite nanoparticles are initially dispersed in ethanol. In some embodiments, at least 95 vol % ethanol is used. In some embodiments, at least 99 vol % ethanol is used. In some embodiments, at least 99.9 vol % ethanol is used. Dispersants and/or surfactants are typically added to the ethanol before suspension of the composite nanoparticles. A suitable surfactant includes DisperBYK®-145 from BYK-Chemie GmbH LLC, Wesel, which can be added in a range of about 2 wt % to about 12 wt %, with about 7 wt % being a typical value, and/or dodecylamine, which can be added in a range of about 0.25 wt % to about 3 wt %, with about 1 wt % being a typical value. Preferably, both DisperBYK®-145 and dodecylamine are used at about 7 wt % and 1 wt %, respectively. In some embodiments, the mixture of ethanol, composite nanoparticles, and surfactants and/or dispersants is sonicated to uniformly disperse the composite nanoparticles. The quantity of composite nanoparticles particles in the dispersion may be in the range of about 5 wt % to about 20 wt %.

Separately from the composite nanoparticle suspension, a gel activation solution is prepared by mixing formaldehyde and propylene oxide. The formaldehyde is preferably in an aqueous solution. In some embodiments, the concentration of the aqueous formaldehyde solution is about 5 wt % to about 50 wt % formaldehyde, about 20 wt % to about 40 wt % formaldehyde, or about 30 wt % to about 40 wt % formaldehyde. Preferably, the aqueous formaldehyde is about 37 wt % formaldehyde. In some embodiments, the aqueous formaldehyde may contain about 5 wt % to about 15 wt % methanol to stabilize the formaldehyde in solution. The aqueous formaldehyde solution can be added in a range of about 25% to about 50% of the final weight of the gel activation solution, with the remainder being propylene oxide. Preferably, the gel activation solution comprises 37.5 wt % of the aqueous formaldehyde solution (which itself comprises 37 wt % formaldehyde) and 62.5 wt % propylene oxide, resulting in a final formaldehyde concentration of about 14 wt % of the final gel activation solution.

Separately from the composite nanoparticle suspension and gel activation solution, an aluminum chloride solution is produced by dissolving aluminum chloride in a mixture of resorcinol and ethanol. Resorcinol can be added at a range of about 10 wt % to about 30 wt %, with about 23 wt % being a typical value. Aluminum chloride can be added at a range of about 2 wt % to about 12 wt %, with about 7 wt % being a typical value.

The composite nanoparticle suspension, gel activation solution, and aluminum chloride solution can be mixed together at a ratio from of about 100:10:10 to about 100:40:40, or about 100:20:20 to about 100:30:30, or about 100:25:25, in terms of (weight of composite nanoparticle suspension):(weight of gel activation solution):(weight of aluminum chloride solution). The final mixture will begin to polymerize into a carrier embedded with composite nanoparticles. The carrier comprises a combustible component, an organic gel, and a non-combustible component, aluminum oxide. The resulting carrier may then be dried (for example, at about 30° C. to about 95° C., preferably about 50° C. to about 60° C., at atmospheric pressure or at reduced pressure such as from about 1 pascal to about 90,000 pascal, for about one day to about 5 days, or for about 2 days to about 3 days). After drying, the resulting carrier may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon), to yield a porous carrier comprising composite catalytic nanoparticles and aluminate. When the composite carrier is calcined under ambient atmosphere or other oxygenated conditions, organic material, such as polymerized resorcinol, formaldehyde, or propylene oxide, is burned off, resulting in a substantially pure aluminum oxide porous carrier embedded with composite nanoparticles. If the composite carrier is calcined under an inert atmosphere, such as argon or nitrogen, the organic materials may become substantially porous amorphous carbon interspersed with the porous aluminum oxide embedded with composite nanoparticles. The resulting porous carrier can be processed, such as by grinding or milling, into a micro-sized powder of NNiM particles.

In another embodiment, composite catalytic nanoparticles may be mixed with a dispersion comprising metal oxide nanoparticles, such as aluminum oxide nanoparticles, and amorphous carbon, such as carbon black. The dispersed solid particles from the resulting dispersed colloid may be separated from the liquid by co-precipitation, dried, and calcined. Upon calcination of the solid material in an ambient or oxygenated environment, the amorphous carbon is exhausted, that is, burned off. Simultaneously, the heat from the calcination process causes the aluminum oxide nanoparticles to sinter together, resulting in pores throughout the precipitated aluminum oxide.

In another embodiment, composite catalytic nanoparticles may be mixed with a dispersion comprising metal oxide nanoparticles, such as cerium oxide nanoparticles, and amorphous carbon, such as carbon black. The dispersed solid particles from the resulting dispersed colloid may be separated from the liquid by co-precipitation, dried, and calcined. Upon calcination of the solid material in an ambient or oxygenated environment, the amorphous carbon is exhausted, that is, burned off. Simultaneously, the heat from the calcination process causes the cerium oxide nanoparticles to sinter together, resulting in pores throughout the precipitated cerium oxide.

In some embodiments, aluminum oxide nanoparticles can be suspended in ethanol, water, or a mix of ethanol and water. Carbon black with an average grain size ranging from about 1 nm to about 200 nm, or about 20 nm to about 100 nm, or about 20 nm to about 50 nm, or about 35 nm, may be added to the aluminum oxide suspension. In some embodiments, sufficient carbon black to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. Composite nanoparticles may be mixed into the dispersion comprising aluminum oxide nanoparticles and carbon black. In some embodiments, the composite nanoparticles are dispersed in a separate colloid, optionally with dispersants or surfactants, before being mixed with the dispersion comprising aluminum oxide nanoparticles and carbon black. The pH of the resulting mixture can be adjusted to a range of about 2 to about 7, such as a pH of between about 3 and about 5, preferably a pH of about 4, allowing the particles to precipitate. The precipitant can be dried (for example, at about 30° C. to about 95° C., preferably about 50° C. to about 70° C., at atmospheric pressure or at reduced pressure such as from about 1 pascal to about 90,000 pascal, for about one day to about 5 days, or for about 2 days to about 3 days). After drying, the carrier may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the aluminum oxide nanoparticles sinter together, yielding a porous aluminum oxide carrier embedded with composite nanoparticles.

In some embodiments, cerium oxide nanoparticles can be suspended in ethanol, water, or a mix of ethanol and water. Carbon black with an average grain size ranging from about 1 nm to about 200 nm, or about 20 nm to about 100 nm, or about 20 nm to about 50 nm, or about 35 nm, may be added to the cerium oxide suspension. In some embodiments, sufficient carbon black to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. Composite nanoparticles may be mixed into the dispersion comprising cerium oxide nanoparticles and carbon black. In some embodiments, the composite nanoparticles are dispersed in a separate colloid, optionally with dispersants or surfactants, before being mixed with the dispersion comprising cerium oxide nanoparticles and carbon black. The pH of the resulting mixture can be adjusted to a range of about 2 to about 7, such as a pH of between about 3 and about 5, preferably a pH of about 4, allowing the particles to precipitate. The precipitant can be dried (for example, at about 30° C. to about 95° C., preferably about 50° C. to about 70° C., at atmospheric pressure or at reduced pressure such as from about 1 pascal to about 90,000 pascal, for about one day to about 5 days, or for about 2 days to about 3 days). After drying, the carrier may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the cerium oxide nanoparticles sinter together, yielding a porous cerium oxide carrier embedded with composite nanoparticles. The resulting carrier may be further processed, for example by grinding or milling, into micron-sized NNiM particles.

Sol-gel preparation can also be used with cerium oxide nanoparticles, or composite particles comprising cerium oxide support nanoparticles with PGM catalyst nanoparticles. SolSperse 46 k is mixed into deionized water and stirred. Then nanoparticles comprising cerium oxide, or composite nanoparticles comprising cerium oxide support nanoparticles and platinum group metal/platinum group metal alloy catalytic particles, are mixed into the solution. The pH of the solution is adjusted with acetic acid to between pH 3.5 and 4.0. The mixture is sonicated in a chilled water bath. The mixture is then centrifuged and the nanoparticle-containing supernatant (“nanoparticle dispersion”) is used in subsequent steps. A 37% formaldehyde solution is prepared. A solution of resorcinol and cerium nitrate in deionized water is prepared. The formaldehyde solution is poured into the nanoparticle dispersion, with stirring. Then the resorcinol-cerium nitrate solution is poured into the formaldehyde/nanoparticle dispersion mixture and stirring is continued. Ammonium Hydroxide (typically 50% v/v with H₂O) is added until the pH of the mixture has reached between 7.5 and 8.5, at which point gel formation will commence. The gel is dried in an air drying oven at about 80-90 C for about 72 hours. The resulting chunks of resinous material are broken up. Then the dried gel is calcined in an oven at about 500 C for about 20 hours. The resulting carrier may be further processed, for example by grinding or milling, into micron-sized NNiM particles.

Procedures similar to those above can be used to produce cerium-zirconium oxide, cerium-zirconium-lanthanum oxide, or cerium-zirconium-lanthanum-yttrium oxide, by using cerium nitrate and zirconium oxynitrate, cerium nitrate, zirconium oxynitrate, and lanthanum acetate, or cerium nitrate, zirconium oxynitrate, lanthanum acetate, and yttrium nitrate in appropriate amounts, respectively.

NNiM Particles with Inhibited Migration of Platinum Group Metals

The NNiM particles, including those made using an aluminum oxide porous carrier and composite nanoparticles, where the carrier is produced by methods described herein and composite nanoparticles produced under reducing conditions, are particularly advantageous for reducing platinum group metal use and to reduce catalyst aging. The platinum group metal of the catalytic nanoparticle has a greater affinity for the partially reduced Al₂O₍₃₋ₓ₎ surface within the composite nanoparticle than, for example, the Al₂O₃ of the porous carrier. Thus, at elevated temperatures, neighboring PGM nanoparticles joined to neighboring Al₂O₍₃₋ₓ₎ components of the composite nanoparticles are less likely to migrate within the NNiM particle and agglomerate into larger catalyst clumps. Since the larger agglomerations of catalyst have less surface area, and are less effective as catalysts, the inhibition of migration and agglomeration provides a significant advantage for the NNiM particles. In contrast, platinum particles deposited by wet-chemical precipitation onto alumina support demonstrate higher mobility and migration, forming agglomerations of catalyst and leading to decreased catalytic efficacy over time (that is, catalyst aging). Additionally, the NNiM particles have greater catalytic surface area accessibility than micro-particles with composite nanoparticles bonded only to the surface or accessible pores of the support micro-particle. The partially reduced Al₂O₍₃₋ₓ₎ surface is formed by using a working gas containing hydrogen during plasma synthesis of the composite nanoparticles, for example, an argon/H₂ mixture; preferably, some amount of palladium (such as 0.1 wt % to 1 wt %, or 1 wt % to 5 wt %, of the feedstock) is also used as a feed metal during formation of the partially reduced Al₂O₍₃₋ₓ₎ surface of the support particles in the composite nanoparticles.

### Washcoat Compositions and Layers Using Nano-on-Nano-in-Micron Catalyst Particles: Application to Substrates

In some embodiments, washcoat formulations comprising the NNiM particles (that is, the composite nanoparticles embedded within a micron-sized porous carrier as described herein) are used to provide one or more layers on a substrate used for catalysis, such as a catalytic converter substrate. The washcoat formulations may be used to form washcoat layers and catalytic converter substrates that include reduced amounts of platinum group metals and/or offer better performance when compared to previous washcoat layers and formulations and catalytic converter substrates.

Washcoats are prepared by suspending NNiM particles in an aqueous solution, adjusting the pH to between about 2 and about 7, to between about 3 and about 5, or to about 4, and adjusting the viscosity, if necessary, using cellulose, cornstarch, or other thickeners, to a value between about 300 cP to about 1200 cP. In some embodiments, the catalytic washcoat are applied to a substrate to produce a coated substrate.

The initial substrate is preferably a catalytic converter substrate that demonstrates good thermal stability, including resistance to thermal shock, and to which the described washcoats can be affixed in a stable manner. Suitable substrates include, but are not limited to, substrates formed from cordierite or other ceramic materials, and substrates formed from metal. The substrates may include a honeycomb structure, which provides numerous channels and results in a high surface area. The high surface area of the coated substrate with its applied washcoats in the catalytic converter provides for effective treatment of the exhaust gas flowing through the catalytic converter.

The washcoat is applied to the substrate by coating the substrate with the aqueous solution comprising NNiM particles, blowing excess washcoat off of the substrate (and optionally collecting and recycling the excess washcoat blown off of the substrate), drying the substrate, and calcining the substrate.

Drying of the washcoats coated onto the substrate can be performed at room temperature or elevated temperature (for example, from about 30° C. to about 95° C., preferably about 60° C. to about 70° C.), at atmospheric pressure or at reduced pressure (for example, from about 1 pascal to about 90,000 pascal, or from about 7.5 mTorr to about 675 Torr), in ambient atmosphere or under an inert atmosphere (such as nitrogen or argon), and with or without passing a stream of gas over the substrate (for example, dry air, dry nitrogen gas or dry argon gas). In some embodiments, the drying process is a hot-drying process. A hot drying process includes any way to remove the solvent at a temperature greater than room temperature, but at a temperature below a standard calcining temperature. In some embodiments, the drying process may be a flash drying process, involving the rapid evaporation of moisture from the substrate via a sudden reduction in pressure or by placing the substrate in an updraft of warm air. It is contemplated that other drying processes may also be used.

After drying the washcoat onto the substrate, the washcoat may then be calcined onto the substrate. Calcining takes place at elevated temperatures, such as from 400° C. to about 700° C., preferably about 500° C. to about 600° C., more preferably at about 540° C. to about 560° C. or at about 550° C. Calcining can take place at atmospheric pressure or at reduced pressure (for example, from about 1 pascal to about 90,000 pascal, or about 7.5 mTorr to about 675 Torr), in ambient atmosphere or under an inert atmosphere (such as nitrogen or argon), and with or without passing a stream of gas over the substrate (for example, dry air, dry nitrogen gas, or dry argon gas). This process yields a substrate coated with a washcoat layer comprising micron-sized porous carrier particles embedded with catalytic composite nanoparticles.

### Catalytic Converters and Methods of Producing Catalytic Converters

In some embodiments, the invention provides for catalytic converters, which comprise a coated substrate coated with a catalytic washcoat layer described herein. The catalytic converters are useful in a variety of applications, such as in diesel vehicles, such as in light-duty diesel vehicles.

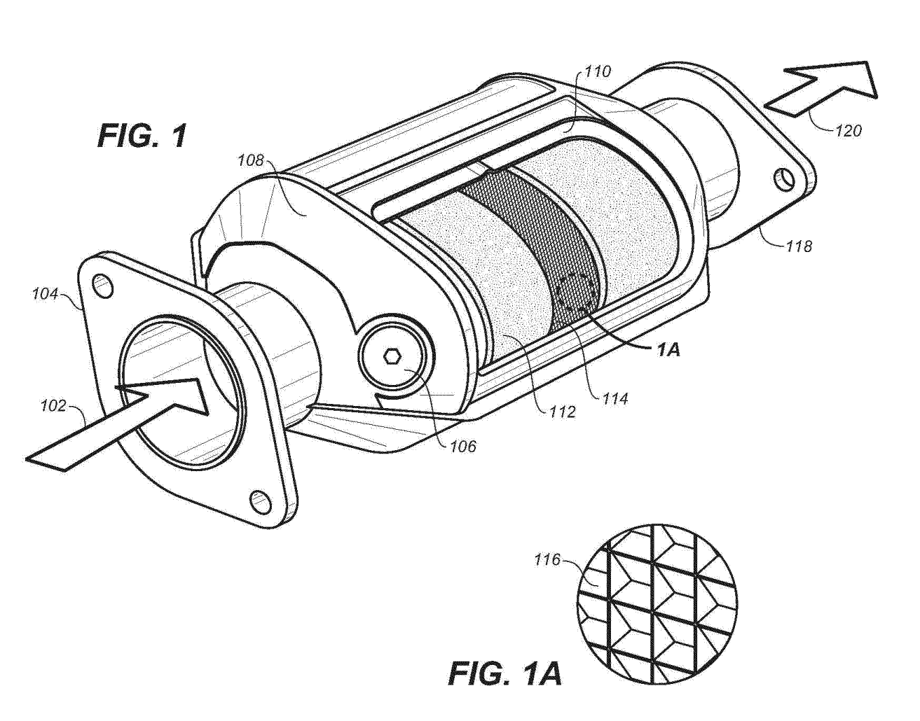

FIG. 1 illustrates a catalytic converter in accordance with some embodiments. Catalytically active material, such as catalytic composite nanoparticles embedded into micron-sized porous carrier particles, is included in a washcoat composition, which is coated onto a substrate to form a coated substrate. The coated substrate 114 is enclosed within an insulating material 112, which in turn is enclosed within a metallic container 110 (of, for example, stainless steel). A heat shield 108 and a gas sensor (for example, an oxygen sensor) 106 are depicted. The catalytic converter may be affixed to the exhaust system of the vehicle through flanges 104 and 118. The exhaust gas, which includes the raw emissions of hydrocarbons, carbon monoxide, and nitrogen oxides, enters the catalytic converter at 102. As the raw emissions pass through the catalytic converter, they react with the catalytically active material on the coated substrate, resulting in tailpipe emissions of water, carbon dioxide, and nitrogen exiting at 120. FIG. 1A is a magnified view of a section of the coated substrate 114, which shows the honeycomb structure of the coated substrate. The coated substrates, which are discussed in further detail below, may be incorporated into a catalytic converter for use in a vehicle emissions control system.

### Exhaust Systems, Vehicles, and Emissions Performance

In some embodiments of the invention, a coated substrate as disclosed herein is housed within a catalytic converter in a position configured to receive exhaust gas from an internal combustion engine, such as in an exhaust system of an internal combustion engine. The coated substrate is placed into a housing, such as that shown in FIG. 1, which can in turn be placed into an exhaust system (also referred to as an exhaust treatment system) of an internal combustion engine. The exhaust system of the internal combustion engine receives exhaust gases from the engine, typically into an exhaust manifold, and delivers the exhaust gases to an exhaust treatment system. The catalytic converter forms part of the exhaust system and is often referred to as the diesel oxidation catalyst (DOC). The exhaust system can also include a diesel particulate filter (DPF) and/or a selective catalytic reduction unit (SCR unit) and/or a lean NOx trap (LNT); typical arrangements, in the sequence that exhaust gases are received from the engine, are DOC-DPF and DOC-DPF-SCR. The exhaust system can also include other components, such as oxygen sensors, HEGO (heated exhaust gas oxygen) sensors, UEGO (universal exhaust gas oxygen) sensors, sensors for other gases, and temperature sensors. The exhaust system can also include a controller such as an engine control unit (ECU), a microprocessor, or an engine management computer, which can adjust various parameters in the vehicle (fuel flow rate, fuel/air ratio, fuel injection, engine timing, valve timing, etc.) in order to optimize the components of the exhaust gases that reach the exhaust treatment system, so as to manage the emissions released into the environment.

### Comparison of Catalyst Performance Described Herein to Commercially Available and Other Non-Commercially Available Catalysts

The NNiM particles described herein may be used for a variety of applications, for example, as a component in various catalytic washcoat formulations to be coated on a substrate, which may be used in a catalytic converter, which may then be used in the exhaust treatment system of an automobile. Commercially available catalytic converters are generally produced using wet-chemistry methods to place platinum group metals, such as palladium or platinum, within a washcoat formulation. Catalytic converters produced using wet-chemistry methods can be compared to catalytic converters using catalytic particles, such as NNm particles, as described in U.S. application Ser. No. 13/589,024 (U.S. Pat. No. 8,679,433), or NNiM particles as described herein.

To compare the catalytic efficiency of wet-chemistry catalysts, NNm particles, and NNiM particles, the catalysts may be separately employed in catalytic converters, aged (for example, by using the catalytic converters with an actual automobile or artificially, such as by heating the catalytic converter to 800° C. for 16 hours), and a carbon monoxide “light-off” temperature may be measured for each catalytic converter at various platinum group metal loadings. A carbon monoxide “light-off” temperature is generally considered the operational temperature of a catalytic converter, and the temperature at which 50% of carbon monoxide is catalyzed. A lower light-off temperature for a given PGM load, or a lower PGM load for a given light-off temperature, is therefore indicative of a more efficient catalyst.

In some embodiments, a catalytic converter made with composite nanoparticles embedded within a porous carrier, loaded with 1.8 g/l of PGM or less, displays a carbon monoxide light-off temperature at least 10 degrees C. lower than a catalytic converter made with wet chemistry methods and having the same or similar PGM loading. In some embodiments, a catalytic converter made with composite nanoparticles embedded within a porous carrier, loaded with 1.8 g/l of PGM or less, displays a carbon monoxide light-off temperature at least 20 degrees C. lower than a catalytic converter made with wet chemistry methods and having the same or similar PGM loading. In some embodiments, a catalytic converter made with composite nanoparticles embedded within a porous carrier, loaded with 1.8 g/l of PGM or less, displays a carbon monoxide light-off temperature at least 30 degrees C. lower than a catalytic converter made with wet chemistry methods and having the same or similar PGM loading. In some embodiments, a catalytic converter made with composite nanoparticles embedded within a porous carrier, loaded with 1.8 g/l of PGM or less, displays a carbon monoxide light-off temperature at least 40 degrees C. lower than a catalytic converter made with wet chemistry methods and having the same or similar PGM loading. In some embodiments, a catalytic converter made with composite nanoparticles embedded within a porous carrier, loaded with 1.8 g/l of PGM or less, displays a carbon monoxide light-off temperature at least 50 degrees C. lower than a catalytic converter made with wet chemistry methods and having the same or similar PGM loading. In some embodiments, a catalytic converter made with composite nanoparticles embedded within a porous carrier, loaded with 1.5 g/l of PGM or less, displays a carbon monoxide light-off temperature at least 10 degrees C. lower than a catalytic converter made with wet chemistry methods and having the same or similar PGM loading. In some embodiments, a catalytic converter made with composite nanoparticles embedded within a porous carrier, loaded with 1.5 g/l of PGM or less, displays a carbon monoxide light-off temperature at least 20 degrees C lower than a catalytic converter made with wet chemistry methods and having the same or similar PGM loading. In some embodiments, a catalytic converter made with composite nanoparticles embedded within a porous carrier, loaded with 1.5 g/l of PGM or less, displays a carbon monoxide light-off temperature at least 30 degrees C. lower than a catalytic converter made with wet chemistry methods and having the same or similar PGM loading. In some embodiments, a catalytic converter made with composite nanoparticles embedded within a porous carrier, loaded with 1.5 g/l of PGM or less, displays a carbon monoxide light-off temperature at least 40 degrees C. lower than a catalytic converter made with wet chemistry methods and having the same or similar PGM loading. In some embodiments, a catalytic converter made with composite nanoparticles embedded within a porous carrier demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−3 degrees C. of the carbon monoxide light-off temperature of a catalytic converter made with wet chemistry methods, while the catalytic converter made with composite nanoparticles embedded within a porous carrier employs 30 wt % less PGM than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−2 degrees C. of the carbon monoxide light-off temperature of a catalytic converter made with wet chemistry methods, while the catalytic converter made with composite nanoparticles embedded within a porous carrier employs 30 wt % less catalyst than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−3 degrees C. of the carbon monoxide light-off temperature of a catalytic converter made with wet chemistry methods, while the catalytic converter made with composite nanoparticles embedded within a porous carrier employs 40 wt % less PGM than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−2 degrees C. of the carbon monoxide light-off temperature of a catalytic converter made with wet chemistry methods, while the catalytic converter made with composite nanoparticles embedded within a porous carrier employs 40 wt % less catalyst than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−3 degrees C. of the carbon monoxide light-off temperature of a catalytic converter made with wet chemistry methods, while the catalytic converter made with composite nanoparticles embedded within a porous carrier employs 50 wt % less PGM than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−2 degrees C. of the carbon monoxide light-off temperature of a catalytic converter made with wet chemistry methods, while the catalytic converter made with composite nanoparticles embedded within a porous carrier employs 50 wt % less catalyst than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−3 degrees C. of the carbon monoxide light-off temperature of a catalytic converter made with wet chemistry methods, while the catalytic converter made with composite nanoparticles embedded within a porous carrier employs 60 wt % less PGM than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−2 degrees C. of the carbon monoxide light-off temperature of a catalytic converter made with wet chemistry methods, while the catalytic converter made with composite nanoparticles embedded within a porous carrier employs 60 wt % less catalyst than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−3 degrees C. of the carbon monoxide light-off temperature of a catalytic converter made with wet chemistry methods, while the catalytic converter made with composite nanoparticles embedded within a porous carrier employs 70 wt % less PGM than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−2 degrees C. of the carbon monoxide light-off temperature of a catalytic converter made with wet chemistry methods, while the catalytic converter made with composite nanoparticles embedded within a porous carrier employs 70 wt % less catalyst than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−3 degrees C. of the carbon monoxide light-off temperature of a catalytic converter made with wet chemistry methods, while the catalytic converter made with composite nanoparticles embedded within a porous carrier employs 80 wt % less PGM than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with composite nanoparticles embedded within a porous carrier displays a carbon monoxide light-off temperature within +/−2 degrees C. of the carbon monoxide light-off temperature of a catalytic converter made with wet chemistry methods, while the catalytic converter made with composite nanoparticles embedded within a porous carrier employs 80 wt % less catalyst than the catalytic converter made with wet chemistry methods. In some embodiments, the catalytic converter made with composite nanoparticles embedded within a porous carrier demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, for the above-described comparisons, both the catalytic converter made with composite nanoparticles embedded within a porous carrier, and the commercially available catalytic converter prepared using wet chemistry methods, are aged (by the same amount) prior to testing. In some embodiments, both the catalytic converter made with composite nanoparticles embedded within a porous carrier, and the commercially available catalytic converter prepared using wet chemistry methods, are aged to about (or up to about) 50,000 kilometers, about (or up to about) 50,000 miles, about (or up to about) 75,000 kilometers, about (or up to about) 75,000 miles, about (or up to about) 100,000 kilometers, about (or up to about) 100,000 miles, about (or up to about) 125,000 kilometers, about (or up to about) 125,000 miles, about (or up to about) 150,000 kilometers, or about (or up to about) 150,000 miles. In some embodiments, for the above-described comparisons, both the catalytic converter made with composite nanoparticles embedded within a porous carrier, and the commercially available catalytic converter prepared using wet chemistry methods, are artificially aged (by the same amount) prior to testing. In some embodiments, they are artificially aged by heating to about 400° C., about 500° C., about 600° C., about 700°, about 800° C., about 900° C., about 1000° C., about 1100° C., or about 1200° C. for about (or up to about) 4 hours, about (or up to about) 6 hours, about (or up to about) 8 hours, about (or up to about) 10 hours, about (or up to about) 12 hours, about (or up to about) 14 hours, about (or up to about) 16 hours, about (or up to about) 18 hours, about (or up to about) 20 hours, about (or up to about) 22 hours, or about (or up to about) 24 hours. In some embodiments, they are artificially aged by heating to about 800° C. for about 16 hours.

### EXEMPLARY EMBODIMENTS

The invention is further described by the following embodiments. The features of each of the embodiments are combinable with any of the other embodiments where appropriate and practical.

### Embodiment 1

A catalytic material comprising: a porous carrier; and a plurality of composite nanoparticles embedded within the porous carrier, wherein each composite nanoparticle comprises a support nanoparticle and a catalytic nanoparticle.

### Embodiment 2

The catalytic material of embodiment 1, wherein the catalytic material is a micron-size particle.

### Embodiment 3

The catalytic material of embodiment 1 or 2, wherein the catalytic nanoparticle comprises at least one platinum group metal.

### Embodiment 4

The catalytic material of any one of embodiments 1-3, wherein the catalytic nanoparticle comprises platinum and palladium.

### Embodiment 5

The catalytic material of embodiment 4, wherein the catalytic nanoparticle comprises platinum and palladium in a weight ratio of 1:2 platinum:palladium to 25:1 platinum:palladium.

### Embodiment 6

The catalytic material of embodiment 4, wherein the catalytic nanoparticle comprises platinum and palladium in a weight ratio of 2:1 platinum:palladium to 10:1 platinum:palladium.

### Embodiment 7

The catalytic material of embodiment 4, wherein the catalytic nanoparticle comprises platinum and palladium in a weight ratio of 2:1 platinum:palladium.

### Embodiment 8

The catalytic material of embodiment 4, wherein the catalytic nanoparticle comprises platinum and palladium in a weight ratio of 10:1 platinum:palladium.

### Embodiment 9

The catalytic material of embodiment 4, wherein the catalytic nanoparticle comprises platinum and is free of palladium.

### Embodiment 10

The catalytic material of embodiment 4, wherein the catalytic nanoparticle comprises palladium and is free of platinum.

### Embodiment 11

The catalytic material of any one of embodiments 1-9, wherein the composite nanoparticles comprise 0.001 wt % to 20 wt % platinum group metal.

### Embodiment 12

The catalytic material of any one of embodiments 1-9, wherein the composite nanoparticles comprise 0.5 wt % to 1.5 wt % platinum group metal.

### Embodiment 13

The catalytic material of any one of embodiments 1-12, wherein the support nanoparticle has an average diameter of 10 nm to 20 nm.

### Embodiment 14

The catalytic material of any one of embodiments 1-13, wherein the catalytic nanoparticle has an average diameter between 0.3 nm and 10 nm.

### Embodiment 15

The catalytic material of any one of embodiments 1-14, wherein the support nanoparticle comprises a metal oxide.

### Embodiment 16

The catalytic material of embodiment 15, wherein the support nanoparticle the metal oxide aluminum oxide.

### Embodiment 17

The catalytic material of any one of embodiments 1-16, wherein the porous carrier is formed from polymerized resorcinol.

### Embodiment 18

The catalytic material of any one of embodiments 1-17, wherein the porous carrier comprises silica.

### Embodiment 19

The catalytic material of any one of embodiments 1-18, wherein the porous carrier is formed from a mixture that comprises amorphous carbon.

### Embodiment 20

The catalytic material of any one of embodiments 1-19, wherein the porous carrier comprises a metal oxide.

### Embodiment 21

The catalytic material of any one of embodiments 1-20, wherein the porous carrier is formed from a mixture that comprises a metal oxide and polymerized resorcinol.

### Embodiment 22

The catalytic material of embodiment 20 or 21, wherein the metal oxide is aluminum oxide.

### Embodiment 23

The catalytic material of any one of embodiments 1-22, wherein the porous carrier has an average pore surface area greater than 200 m²/g.

### Embodiment 24

The catalytic material of any one of embodiments 1-23, wherein the porous carrier has an average pore diameter of 1 nm to 200 nm.

### Embodiment 25

A method of producing a porous catalytic material comprising:

mixing composite nanoparticles with a fluid comprising a carrier precursor, wherein the composite nanoparticles comprise a support nanoparticle and a catalytic nanoparticle;

solidifying the carrier precursor to form a solidified carrier, wherein the composite nanoparticles are embedded within the solidified carrier; and

removing a portion of the solidified carrier to form a porous catalytic material.

### Embodiment 26

The method according to embodiment 25, wherein removing a portion of the solidified carrier comprises calcining the solidified carrier to burn off a portion of the solidified carrier.

### Embodiment 27

The method according to embodiment 25 or 26, further comprising:

forming a fluid comprising dispersed composite nanoparticles prior to mixing the composite nanoparticles with the fluid containing a carrier precursor.

### Embodiment 28

The method of embodiment 25 or 26, wherein the carrier precursor comprises one or more of aluminum, silica, resorcinol, or amorphous carbon.

### Embodiment 29

The methods of any one of embodiments 22-28, wherein the carrier precursor is solidified by precipitation and the composite nanoparticles co-precipitate with the solidified carrier.

### Embodiment 30

The method of any one of embodiments 25-28, wherein the carrier precursor is solidified by polymerization.

### Embodiment 31

The method of any one of embodiments 25-30, wherein the catalytic nanoparticle comprises at least one platinum group metal.

### Embodiment 32

The method of any one of embodiments 25-31, wherein the catalytic nanoparticle comprises platinum and palladium.

### Embodiment 33

The method of embodiment 32, wherein the catalytic nanoparticle comprises platinum and palladium in a weight ratio of 1:2 platinum:palladium to 25:1 platinum:palladium.

### Embodiment 34

The method of embodiment 32, wherein the catalytic nanoparticle comprises platinum and palladium in a weight ratio of 2:1 platinum:palladium to 10:1 platinum:palladium.

### Embodiment 35

The method of embodiment 32, wherein the catalytic nanoparticle comprises platinum and palladium in a weight ratio of 2:1 platinum:palladium.

### Embodiment 36

The method of embodiment 32, wherein the catalytic nanoparticle comprises platinum and palladium in a weight ratio of 10:1 platinum:palladium.

### Embodiment 37

The method of any one of embodiments 25-31, wherein the catalytic nanoparticle comprises platinum and is free of palladium.

### Embodiment 38

The method of any one of embodiments 25-31, wherein the catalytic nanoparticle comprises palladium and is free of platinum.

### Embodiment 39

The methods of any one of embodiments 25-38, wherein the composite nanoparticles comprise 0.001% to 20% platinum group metal.

### Embodiment 40

The methods of any one of embodiments 25-39, wherein the composite nanoparticles comprise 0.5% to 1.5% platinum group metal.

### Embodiment 41

The method of any one of embodiments 25-40, wherein the support nanoparticle has an average diameter of 10 nm to 20 nm.

### Embodiment 42

The method of any one of embodiments 25-41, wherein the catalytic nanoparticle has an average diameter between 0.3 nm and 10 nm.

### Embodiment 43

The method of any one of embodiments 25-42, wherein the support nanoparticle comprises a metal oxide.

### Embodiment 44

The method of embodiment 43, wherein the metal oxide is aluminum oxide.

### Embodiment 45

The method of any one of embodiment 25-44, further comprising processing the resulting catalytic material into micron-sized particles.

### Embodiment 46

The method of embodiment 45, wherein the resulting catalytic material is ground to form micron-sized particles.

### Embodiment 47

A porous catalytic material made by the method of any one of embodiments 25-46.

### Embodiment 48

A coated substrate comprising: a substrate; and a washcoat layer comprising catalytically active particles, wherein the catalytically active particles comprise a porous carrier and a plurality of composite nanoparticles embedded within the porous carrier, wherein each composite nanoparticle comprises a support nanoparticle and a catalytic nanoparticle.

### Embodiment 49

The coated substrate of embodiment 48, wherein the catalytic nanoparticle comprises at least one platinum group metal.

### Embodiment 50

The coated substrate of embodiments 48 or 49, wherein the catalytic nanoparticle comprises platinum and palladium.

### Embodiment 51

The coated substrate of any one of embodiments 48-50, wherein the porous carrier is formed from polymerized resorcinol.

### Embodiment 52

The coated substrate of any one of embodiments 48-51, wherein the porous carrier comprises silica.

### Embodiment 53

The coated substrate of any one of embodiments 48-52, wherein the porous carrier is formed from a mixture that comprises amorphous carbon.

### Embodiment 54

The coated substrate of any one of embodiments 48-53, wherein the porous carrier comprises a metal oxide.

### Embodiment 55

The coated substrate of any one of embodiments 48-54, wherein the porous carrier is formed from a mixture that comprises a metal oxide and polymerized resorcinol.

### Embodiment 56

The coated substrate of embodiment 54 or 55, wherein the metal oxide is aluminum oxide.

### Embodiment 57

The coated substrate of any one of embodiments 48-56, wherein the porous carrier has an average pore surface area greater than 200 m²/g.

### Embodiment 58

The coated substrate of any one of embodiments 48-57, wherein the porous carrier has an average pore diameter of 1 nm to 200 nm.

### Embodiment 59

The coated substrate of any one of embodiments 48-58, wherein the substrate comprises cordierite.

### Embodiment 60

The coated substrate of any one of embodiments 48-59, wherein the substrate comprises a honeycomb structure.

### Embodiment 61

A catalytic converter comprising a coated substrate according to any one of embodiments 48-60.

### Embodiment 62

An exhaust treatment system comprising a conduit for exhaust gas and a catalytic converter according to embodiment 61.

### Embodiment 63

A washcoat composition comprising catalytically active particles, wherein the catalytically active particles comprise a porous carrier and a plurality of composite nanoparticles embedded within the porous carrier, wherein each composite nanoparticle comprises a support nanoparticle and a catalytic nanoparticle.

### Embodiment 64

The washcoat composition of embodiment 63, wherein the catalytically active particles are suspended in an aqueous medium at a pH between 3 and 5.

### Embodiment 65

The washcoat composition of embodiment 63 or 64, wherein the catalytic nanoparticle comprises at least one platinum group metal.

### Embodiment 66

The washcoat composition of any one of embodiments 63-65, wherein the catalytic nanoparticle comprises platinum and palladium.

### Embodiment 67

The washcoat composition of any one of embodiments 63-66, wherein the porous carrier is formed from polymerized resorcinol.

### Embodiment 68

The washcoat composition of any one of embodiments 63-67, wherein the porous carrier comprises silica.

### Embodiment 69

The washcoat composition of any one of embodiments 63-68, wherein the porous carrier is formed from a mixture that comprises amorphous carbon.

### Embodiment 70

The washcoat composition of any one of embodiments 63-69, wherein the porous carrier comprises a metal oxide.

### Embodiment 71

The washcoat composition of any one of embodiments 63-70, wherein the porous carrier is formed from a mixture that comprises a metal oxide and polymerized resorcinol.

### Embodiment 72

The washcoat composition of embodiment 70 or 71, wherein the metal oxide is aluminum oxide.

### Embodiment 73

The washcoat composition of any one of embodiments 63-72, wherein the porous carrier has an average pore surface area greater than 200 m²/g.

### Embodiment 74

The washcoat composition of any one of embodiments 63-73, wherein the porous carrier has an average pore diameter of 1 nm to 200 nm.

### Embodiment 75

A method of forming a coated substrate comprising coating a substrate with a washcoat composition according to any one of embodiments 63-74.

### Embodiment 76

The method of forming a coated substrate according to embodiment 75, the method further comprising calcining the substrate after coating with the washcoat composition.

### Embodiment 77

A catalytic material comprising: a carrier comprising a combustible component and a non-combustible component; and a plurality of composite nanoparticles embedded within the gel, wherein each composite nanoparticle comprises a support nanoparticle and a catalytic nanoparticle.

### Embodiment 78

The catalytic material of embodiment 77, wherein the combustible component is amorphous carbon.

### Embodiment 79

The catalytic material of embodiment 78, wherein the combustible component is a combustible gel.

### Embodiment 80

The catalytic material of embodiment 77 or 79, wherein the combustible component is polymerized resorcinol.

### Embodiment 81

The catalytic material of any one of embodiments 77-80, wherein the catalytic nanoparticle comprises at least one platinum group metal.

### Embodiment 82

The catalytic material of any one of embodiments 77-81, wherein the catalytic nanoparticle comprises platinum and palladium.

### Embodiment 83

The catalytic material of embodiment 82, wherein the catalytic nanoparticle comprises platinum and palladium in a weight ratio of 1:2 platinum:palladium to 25:1 platinum:palladium.

### Embodiment 84

The catalytic material of embodiment 82, wherein the catalytic nanoparticle comprises platinum and palladium in a weight ratio of 2:1 platinum:palladium to 10:1 platinum:palladium.

### Embodiment 85

The catalytic material of embodiment 82, wherein the catalytic nanoparticle comprises platinum and palladium in a weight ratio of 2:1 platinum:palladium.

### Embodiment 86

The catalytic material of embodiment 82, wherein the catalytic nanoparticle comprises platinum and palladium in a weight ratio of 10:1 platinum:palladium.

### Embodiment 87

The catalytic material of embodiment 81, wherein the catalytic nanoparticle comprises platinum and is free of palladium.

### Embodiment 88

The catalytic material of embodiment 81, wherein the catalytic nanoparticle comprises palladium and is free of platinum.

### Embodiment 89

The catalytic material of any one of embodiments 77-88, wherein the composite nanoparticles comprise 0.001 wt % to 20 wt % platinum group metal.

### Embodiment 90

The catalytic material of any one of embodiments 77-89, wherein the composite nanoparticles comprise 0.5 wt % to 1.5 wt % platinum group metal.

### Embodiment 91

The catalytic material of any one of embodiments 77-90, wherein the support nanoparticle has an average diameter of 10 nm to 20 nm.

### Embodiment 92

The catalytic material of any one of embodiments 77-91, wherein the catalytic nanoparticle has an average diameter between 0.3 nm and 10 nm.

### Embodiment 93

The catalytic material of any one of embodiments 77-92, wherein the support nanoparticle comprises a metal oxide.

### Embodiment 94

The catalytic material of embodiment 93, wherein the support nanoparticle the metal oxide aluminum oxide.

### Embodiment 95

A method of producing a catalytic material comprising: mixing composite nanoparticles with a fluid comprising a carrier precursor, wherein the composite nanoparticles comprise a support nanoparticle and a catalytic nanoparticle; and solidifying the carrier precursor to form a solidified carrier, wherein the composite nanoparticles are embedded within the solidified carrier.

### Embodiment 96

The method according to embodiment 95, further comprising: forming a fluid comprising dispersed composite nanoparticles prior to mixing the composite nanoparticles with the fluid containing a carrier precursor.

### Embodiment 97

The method according to embodiment 95 or 96, wherein the carrier precursor comprises a combustible component and a non-combustible component.

### Embodiment 98

The method according to embodiment 97, wherein the combustible component comprises resorcinol or amorphous carbon.

### Embodiment 99

The method according to embodiment 97 or 98, wherein the non-combustible component comprises aluminum or silica.

### Embodiment 100

The methods of any one of embodiments 95-99, wherein the carrier precursor is solidified by precipitation and the composite nanoparticles co-precipitate with the solidified carrier.

### Embodiment 101

The method of any one of embodiments 95-99, wherein the carrier precursor is solidified by polymerization.

### Embodiment 102

The method of any one of embodiments 95-101, wherein the catalytic nanoparticle comprises at least one platinum group metal.

### Embodiment 103

The method of any one of embodiments 95-102, wherein the catalytic nanoparticle comprises platinum and palladium.

### Embodiment 104

The method of embodiment 103, wherein the catalytic nanoparticle comprises platinum and palladium in a weight ratio of 1:2 platinum:palladium to 25:1 platinum:palladium.

### Embodiment 105

The method of embodiment 103, wherein the catalytic nanoparticle comprises platinum and palladium in a weight ratio of 2:1 platinum:palladium to 10:1 platinum:palladium.

### Embodiment 106

The method of embodiment 103, wherein the catalytic nanoparticle comprises platinum and palladium in a weight ratio of 2:1 platinum:palladium.

### Embodiment 107

The method of embodiment 103, wherein the catalytic nanoparticle comprises platinum and palladium in a weight ratio of 10:1 platinum:palladium.

### Embodiment 108

The method of any one of embodiments 95-102, wherein the catalytic nanoparticle comprises platinum and is free of palladium.

### Embodiment 109

The method of any one of embodiments 95-102, wherein the catalytic nanoparticle comprises palladium and is free of platinum.

### Embodiment 110

The method of any one of embodiments 95-109, wherein the composite nanoparticles comprise 0.001% to 20% platinum group metal.

### Embodiment 111

The method of any one of embodiments 95-110, wherein the composite nanoparticles comprise 0.5% to 1.5% platinum group metal.

### Embodiment 112

The method of any one of embodiments 95-111, wherein the support nanoparticle has an average diameter of 10 nm to 20 nm.

### Embodiment 113

The method of any one of embodiments 95-112, wherein the catalytic nanoparticle has an average diameter between 0.3 nm and 10 nm.

### Embodiment 114

The method of any one of embodiments 95-113, wherein the support nanoparticle comprises a metal oxide.

### Embodiment 115

The method of embodiment 114, wherein the metal oxide is aluminum oxide.

### Embodiment 116

A catalytic material made by the method of any one of embodiments 95-115.

### Embodiment 117

A porous material comprising nanoparticles and a porous carrier material.

### Embodiment 118

The porous material of embodiment 117, wherein the nanoparticles are selected from the group consisting of metal oxide nanoparticles, mixed-metal oxide nanoparticles, and composite nanoparticles.

### Embodiment 119

The porous material of embodiment 117, wherein the nanoparticles comprise metal oxide nanoparticles.

### Embodiment 120

The porous material of embodiment 117, wherein the nanoparticles comprise mixed-metal oxide nanoparticles.

### Embodiment 121

The porous material of embodiment 117, wherein the nanoparticles comprise composite nanoparticles.

### Embodiment 122

The porous material of embodiment 117, wherein the nanoparticles comprise metal oxide nanoparticles and composite nanoparticles.

### Embodiment 123

The porous material of embodiment 117, wherein the nanoparticles comprise mixed-metal oxide nanoparticles and composite nanoparticles.

### Embodiment 124

The porous material of embodiment 117, wherein the nanoparticles comprise metal oxide nanoparticles and mixed-metal oxide nanoparticles.

### Embodiment 125

The porous material of embodiment 117, wherein the nanoparticles comprise metal oxide nanoparticles, mixed-metal oxide nanoparticles, and composite nanoparticles.

### Embodiment 126

The porous material of any one of embodiments 119, 122, 124, or 125, wherein the metal oxide nanoparticles comprise aluminum oxide.

### Embodiment 127

The porous material of any one of embodiments 119, 122, 124, or 125, wherein the metal oxide nanoparticles comprise cerium oxide.

### Embodiment 128

The porous material of any one of embodiments 119, 122, 124, or 125, wherein the metal oxide nanoparticles comprise aluminum oxide nanoparticles and cerium oxide nanoparticles.

### Embodiment 129

The porous material of any one of embodiments 121, 122, 123, or 125, wherein the composite nanoparticles comprise a catalytic nanoparticle and a support nanoparticle.

### Embodiment 130

The porous material of embodiment 117, wherein the nanoparticles comprise aluminum oxide nanoparticles and composite nanoparticles.

### Embodiment 131

The porous material of embodiment 130, wherein the catalytic nanoparticles of the composite nanoparticles comprise platinum, palladium, or an alloy of platinum and palladium.

### Embodiment 132

The porous material of embodiment 130, wherein the support nanoparticles of the composite nanoparticles comprise aluminum oxide.

### Embodiment 133

The porous material of embodiment 130, wherein the catalytic nanoparticles of the composite nanoparticles comprise platinum, palladium, or an alloy of platinum and palladium, and the support nanoparticles of the composite nanoparticles comprise aluminum oxide.

### Embodiment 134

The porous material of any one of embodiments 117-126 or 128-133, wherein the porous carrier material is aluminum oxide.

### Embodiment 135

The porous material of embodiment 117, wherein the nanoparticles comprise cerium oxide nanoparticles and composite nanoparticles.

### Embodiment 136

The porous material of embodiment 135, wherein the catalytic nanoparticles of the composite nanoparticles comprise platinum, palladium, or an alloy of platinum and palladium.

### Embodiment 137

The porous material of embodiment 135, wherein the support nanoparticles of the composite nanoparticles comprise cerium oxide.

### Embodiment 138

The porous material of embodiment 135, wherein the catalytic nanoparticles of the composite nanoparticles comprise platinum, palladium, or an alloy of platinum and palladium, and the support nanoparticles of the composite nanoparticles comprise cerium oxide.

### Embodiment 139

The porous material of any one of embodiments 117-125, 127-131, or 135-138, wherein the porous carrier material is cerium oxide.

### Embodiment 140

The porous material of any one of embodiments 118, 121-123, 125, 129-133, or 135-138, wherein the support nanoparticles of the composite nanoparticles comprise a mixed-metal oxide.

### EXAMPLES

### Example 1

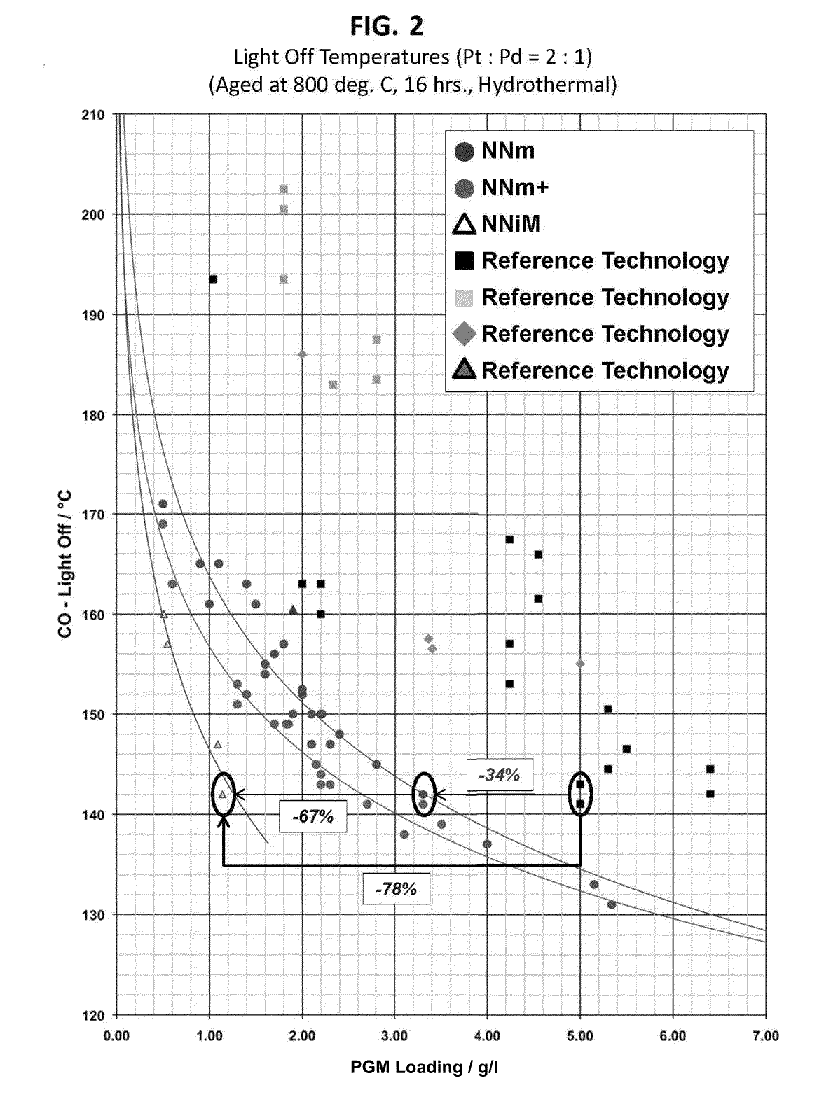

FIG. 2 illustrates the performance of a non-commercially available catalytic converter prepared using composite nanoparticles embedded within porous carrier particles (‘nano-on-nano-in-micro” or “NNiM: particles) as described herein, compared to commercially available catalytic converters having a substrate prepared using wet-chemistry methods, and non-commercially available catalytic converters utilizing composite catalytic nanoparticles impregnated on the surface of micron carrier aluminum oxide particles (“nano-on-nano-on-micro” or “NNm” particles), as described in U.S. application Ser. No. 13/589,024 (U.S. Pat. No. 8,679,433). All test results described below utilize catalysts that were artificially aged at 800° C. for 16 hours to simulate operation after 125,000 miles in a car.

The open triangles (A) represent data points for the carbon monoxide light-off temperatures for the coated substrate prepared with a washcoat having nano-on-nano-in-micron (NNiM) catalyst (where the PGM is 2:1 Pt:Pd). The filled squares (▪), filled diamonds (♦), and filled triangles (▴) indicate the CO light-off temperatures for a commercially available coated substrate prepared by wet-chemistry methods where the PGM is 2:1 Pt:Pd (Reference Technologies). The filled circles () indicate the carbon monoxide light-off temperatures for non-commercially available catalytic converters utilizing composite catalytic nanoparticles impregnated on the surface of micron carrier aluminum oxide particles (“nano-on-nano-on-micro” or “NNm” particles), as described in U.S. application Ser. No. 13/589,024 (U.S. Pat. No. 8,679,433).

The simulation is performed under steady-state conditions for experimental purposes (in actual operation, cold-start conditions are not steady-state). A carrier gas comprising carbon monoxide is passed over the coated substrates, in order to simulate diesel exhaust. The temperature of the catalytic converter substrate is gradually raised until the light-off temperature is achieved (that is, when the coated substrate reaches a temperature sufficient to convert 50% of the CO into CO₂).

The commercially available catalytic converter displays CO light-off temperatures of about 193° C. at a PGM loading of 1.0 g/l. The non-commercially available catalytic converter using NNm particles, as described in U.S. application Ser. No. 13/589,024 (U.S. Pat. No. 8,679,433), displays a CO light-off temperature of about 161° C. at 1.0 g/l PGM loading. The catalytic converter using NNiM particles displays CO light-off temperatures of about 142° C. and about 147° C. (for an average of about 144.5° C.) at a PGM loading of 1.1 g/l, and a CO light-off temperature of about 146° C. at a PGM loading of 1.0 g/l can be estimated, or about 47° C. lower than the commercially available catalytic converter at similar PGM loading, and about 15° C. lower than the non-commercially available coated substrate using NNm particles, as described in U.S. application Ser. No. 13/589,024 (U.S. Pat. No. 8,679,433), at similar PGM loading.

The commercially available catalytic converter displays a carbon monoxide light-off temperature of about 142° C. at a PGM loading of about 5.0 g/l. The non-commercially available catalytic converter using NNm particles, as described in U.S. application Ser. No. 13/589,024 (U.S. Pat. No. 8,679,433), displays a carbon monoxide light-off temperature of about 142° C. at a PGM loading of about 3.3 g/l. The catalytic converter using NNiM particles displays a carbon monoxide light-off temperature of about 142° C. at a PGM loading of about 1.1 g/l. This represents a thrifting (reduction) in PGM loading for the catalytic converter using NNiM particles of about 78% relative to the commercially available coated substrate, and of about 67% relative to the non-commercially available coated substrate using NNm particles, as described in U.S. application Ser. No. 13/589,024 (U.S. Pat. No. 8,679,433), at a light-off temperature of about 142° C.

### Example 2

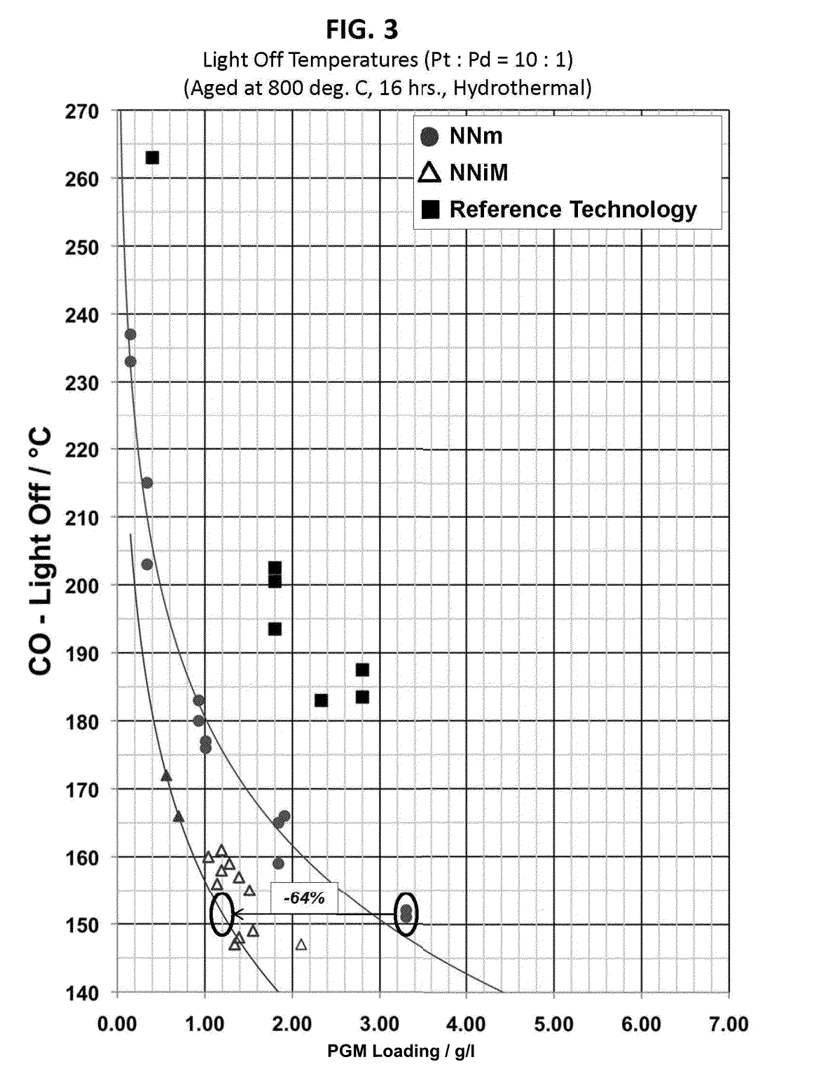

FIG. 3 illustrates a similar simulation to simulation illustrated by FIG. 1, except the ratio of PGM is 10:1 Pt:Pd for each technology.

The open triangles (Δ) represent data points for the carbon monoxide light-off temperatures for the catalytic converter prepared using nano-on-nano-in-micron (NNiM) particles (where the PGM is 10:1 Pt:Pd). The filled squares (▪) indicate the CO light-off temperatures for a commercially available catalytic converter prepared by wet-chemistry methods (where the PGM is 10:1 Pt:Pd). The filled circles () indicate the carbon monoxide light-off temperatures for non-commercially available catalytic converters utilizing composite catalytic nanoparticles impregnated on the surface of micron carrier aluminum oxide particles (“nano-on-nano-on-micro” or “NNm” particles), as described in U.S. application Ser. No. 13/589,024 (U.S. Pat. No. 8,679,433).

The commercially available catalytic converter displays carbon monoxide light-off temperatures of about 203° C., about 201° C., and about 194° C. (for an average of about 199° C.) at a PGM loading of 1.8 g/l. The non-commercially available catalytic converter using NNm particles, as described in U.S. application Ser. No. 13/589,024 (U.S. Pat. No. 8,679,433), displays carbon monoxide light-off temperatures of about 166° C., about 165° C., and about 159° C. (for an average of about 163° C.) at a PGM loading of about 1.8 g/l PGM loading. The catalytic converter prepared using NNiM particles displays a carbon monoxide light-off temperature of about 140° C. at a PGM loading of about 1.8 g/l, or about 59° C. lower than the commercially available catalytic converter at similar PGM loading, and about 23° C. lower than the non-commercially available catalytic converter prepared using NNm particles, as described in U.S. application Ser. No. 13/589,024 (U.S. Pat. No. 8,679,433), at similar PGM loading.

The non-commercially available catalytic converter prepared using NNm particles, as described in U.S. application Ser. No. 13/589,024 (U.S. Pat. No. 8,679,433), with a PGM ratio of 10:1 displays a carbon monoxide light-off temperature of about 151° C. at a PGM loading of about 3.3 g/l. The catalytic converter prepared using NNiM particles displays a carbon monoxide light-off temperature of about 151° C. at a PGM loading of about 1.2 g/l. This represents a thrifting (reduction) in PGM loading for the catalytic converter prepared using NNiM particles of about 64% relative to the non-commercially available catalytic converter prepared using NNm particles, as described in U.S. application Ser. No. 13/589,024 (U.S. Pat. No. 8,679,433), at a light-off temperature of about 142° C.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications can be made in the embodiments chosen for illustration without departing from the spirit and scope of the invention. Therefore, the description and examples should not be construed as limiting the scope of the invention.

1. A catalytic material comprising:
a porous carrier; and
a plurality of composite nanoparticles embedded within the porous carrier, wherein each composite nanoparticle comprises a support nanoparticle and a catalytic nanoparticle.

2. The catalytic material of claim 1, wherein the catalytic material comprises micron-size particles.

3. The catalytic material of claim 1, wherein the catalytic nanoparticle comprises at least one platinum group metal.

4. The catalytic material of claim 1, wherein the catalytic nanoparticle comprises rhodium, platinum, or palladium.

5-11. (canceled)

12. The catalytic material of claim 1, wherein the composite nanoparticles comprise 0.001 wt % to 20 wt % platinum group metal.

13. (canceled)

14. The catalytic material of claim 1, wherein the support nanoparticle has an average diameter of 10 nm to 20 nm.

15. The catalytic material of claim 1, wherein the catalytic nanoparticle has an average diameter between 0.3 nm and 10 nm.

16. The catalytic material of claim 1, wherein the support nanoparticle comprises a metal oxide.

17. The catalytic material of claim 16, wherein the metal oxide comprises aluminum oxide or cerium oxide.

18. (canceled)

19. The catalytic material of claim 16, wherein the metal oxide comprises a material selected from the group consisting of cerium-zirconium oxide, cerium-zirconium-lanthanum oxide, and cerium-zirconium-lanthanum-yttrium oxide.

20. The catalytic material of claim 1, wherein the porous carrier is formed from polymerized resorcinol or a mixture that comprises amorphous carbon.

21. The catalytic material of claim 1, wherein the porous carrier comprises silica.

22. (canceled)

23. The catalytic material of claim 1, wherein the porous carrier comprises a metal oxide.

24. The catalytic material of claim 1, wherein the porous carrier is formed from a mixture that comprises a metal oxide and polymerized resorcinol.

25. The catalytic material of claim 23, wherein the metal oxide is aluminum oxide or cerium oxide.

26. (canceled)

27. The catalytic material of claim 23, wherein the metal oxide comprises a material selected from the group consisting of cerium-zirconium oxide, cerium-zirconium-lanthanum oxide, and cerium-zirconium-lanthanum-yttrium oxide.

28-29. (canceled)

30. A method of producing a porous catalytic material comprising:
mixing composite nanoparticles with a fluid comprising a carrier precursor, wherein the composite nanoparticles comprise a support nanoparticle and a catalytic nanoparticle;
solidifying the carrier precursor to form a solidified carrier, wherein the composite nanoparticles are embedded within the solidified carrier; and
removing a portion of the solidified carrier to form a porous catalytic material.

31. The method according to claim 30, wherein removing a portion of the solidified carrier comprises calcining the solidified carrier to burn off a portion of the solidified carrier.

32. The method according to claim 30, further comprising:
forming a fluid comprising dispersed composite nanoparticles prior to mixing the composite nanoparticles with the fluid containing a carrier precursor.

33. The method of claim 30, wherein the carrier precursor comprises one or more of aluminum, silica, resorcinol, or amorphous carbon.

34. The methods of claim 30, wherein the carrier precursor is solidified by precipitation and the composite nanoparticles co-precipitate with the solidified carrier.

35. The method of claim 30, wherein the carrier precursor is solidified by polymerization.

36. The method of claim 30, wherein the catalytic nanoparticle comprises at least one platinum group metal.

37. The method of claim 30, wherein the catalytic nanoparticle comprises rhodium, platinum, or palladium.

38-44. (canceled)

45. The methods of claim 30, wherein the composite nanoparticles comprise 0.001% to 20% platinum group metal.

46. (canceled)

47. The method of claim 30, wherein the support nanoparticle has an average diameter of 10 nm to 20 nm.

48. The method of claim 30, wherein the catalytic nanoparticle has an average diameter between 0.3 nm and 10 nm.

49. The method of claim 30, wherein the support nanoparticle comprises a metal oxide.

50. The method of claim 49, wherein the metal oxide is aluminum oxide or cerium oxide.

51. (canceled)

52. The method of claim 49, wherein the metal oxide comprises a material selected from the group consisting of cerium-zirconium oxide, cerium-zirconium-lanthanum oxide, and cerium-zirconium-lanthanum-yttrium oxide.

53. The method of claim 30, further comprising processing the resulting catalytic material into micron-sized particles.

54-91. (canceled)

92. A catalytic material comprising:
a carrier comprising a combustible component and a non-combustible component; and
a plurality of composite nanoparticles embedded within the carrier, wherein each composite nanoparticle comprises a support nanoparticle and a catalytic nanoparticle.

93. The catalytic material of claim 92, wherein the combustible component is amorphous carbon or a combustible gel.

94-95. (canceled)

96. The catalytic material of claim 92, wherein the catalytic nanoparticle comprises at least one platinum group metal.

97. The catalytic material of claim 96, wherein the catalytic nanoparticle comprises rhodium, platinum, or palladium.

98-104. (canceled)

105. The catalytic material of claim 92, wherein the composite nanoparticles comprise 0.001 wt % to 20 wt % platinum group metal.

106. (canceled)

107. The catalytic material of claim 92, wherein the support nanoparticle has an average diameter of 10 nm to 20 nm.

108. The catalytic material of claim 92, wherein the catalytic nanoparticle has an average diameter between 0.3 nm and 10 nm.

109. The catalytic material of claim 92, wherein the support nanoparticle comprises a metal oxide.

110. The catalytic material of claim 109, wherein the support nanoparticle comprises aluminum oxide or cerium oxide.

111. (canceled)

112. The catalytic material of claim 109, wherein the support nanoparticle comprises a material selected from the group consisting of cerium-zirconium oxide, cerium-zirconium-lanthanum oxide, and cerium-zirconium-lanthanum-yttrium oxide.

113. A method of producing a catalytic material comprising:
mixing composite nanoparticles with a fluid comprising a carrier precursor, wherein the composite nanoparticles comprise a support nanoparticle and a catalytic nanoparticle; and
solidifying the carrier precursor to form a solidified carrier, wherein the composite nanoparticles are embedded within the solidified carrier.

114. The method according to claim 113, further comprising:
forming a fluid comprising dispersed composite nanoparticles prior to mixing the composite nanoparticles with the fluid containing a carrier precursor.

115. The method according to claim 113, wherein the carrier precursor comprises a combustible component and a non-combustible component.

116. The method according to claim 115, wherein the combustible component comprises resorcinol or amorphous carbon.

117. The method according to claim 115, wherein the non-combustible component comprises alumina or silica.

118. The method according to claim 115, wherein the non-combustible component comprises cerium oxide, cerium-zirconium oxide, cerium-zirconium-lanthanum oxide, or cerium-zirconium-lanthanum-yttrium oxide.

119. The method of claim 113, wherein the carrier precursor is solidified by precipitation and the composite nanoparticles co-precipitate with the solidified carrier.

120. The method of claim 113, wherein the carrier precursor is solidified by polymerization.

121. The method of claim 113, wherein the catalytic nanoparticle comprises at least one platinum group metal.

122. The method of claim 113, wherein the catalytic nanoparticle comprises rhodium, platinum, or palladium.

123-129. (canceled)

130. The method of claim 113, wherein the composite nanoparticles comprise 0.001% to 20% platinum group metal.

131. (canceled)

132. The method of claim 113, wherein the support nanoparticle has an average diameter of 10 nm to 20 nm.

133. The method of claim 113, wherein the catalytic nanoparticle has an average diameter between 0.3 nm and 10 nm.

134. The method of claim 113, wherein the support nanoparticle comprises a metal oxide.

135. The method of claim 134, wherein the metal oxide is aluminum oxide or cerium oxide.

136. (canceled)

137. The method of claim 134, wherein the metal oxide is selected from the group consisting of cerium-zirconium oxide, cerium-zirconium-lanthanum oxide, and cerium-zirconium-lanthanum-yttrium oxide.

138-162. (canceled)
